(19) United States
(12) Patent Application Publication
(10) Pub. No.: US 2007/0066627 A1
(43) Pub. Date: Mar. 22, 2007

(54) Hydrazone derivatives for combatting harmful insects and arachnids

(76) Inventors: Michael Hofmann, Ludwigshafen (DE); Markus Kordes, Frankenthal (DE); Udo Lange, Berlin (DE); Ernst Baumann, Dudenhofen (DE); Wolfgang von Deyn, Neustadt (DE); Michael Puhl, Lampertheim (DE); Thomas Schmidt, Neustadt (DE); Gerd Steiner, Kirchheim (DE); Michael F. Treacy, Corpus Christi, TX (US); Deborah L. Culbertson, Fuquay Varina, NC (US); Toni Bucci, Fuquay Varina, NC (US); Hong-Ming Shieh, Newtown, PA (US); Lester L. Maravetz, Westfield, NJ (US)

Correspondence Address: HUTCHISON LAW GROUP PLLC, PO BOX 31686, RALEIGH, NC, 27612, US

(21) Appl. No.: 10/557,881

(22) PCT Filed: May 26, 2004
(86) PCT No.: PCT/EP04/05681

§ 371 Date: Nov. 21, 2005

(51) Int. Cl. A01N 43/82; A01N 43/78; A01N 43/56; A01N 43/06; A01N 43/40; A01N 43/08; A01N 43/80; A01N 43/50

(52) U.S. Cl. 514/255.06; 514/357; 514/362; 514/370; 514/378; 514/400; 514/406; 514/447; 514/454; 514/443; 514/419; 514/471; 514/521; 514/602; 514/614

(57) ABSTRACT

The present invention relates to a method for combating insects or arachnids which comprises contacting the insects or the arachnids, their habitat, breeding ground, food supply, plant, seed, soil, area, material or environment in which the insects or the arachnids are growing or may grow, or the materials, plants, seeds, soils, surfaces or spaces to be protected from insect or arachnid attack or infestation with a pesticidally effective amount of a compound of the general formula (I) or a salt thereof wherein: Ar is a cyclic radical, n is 0 or 1, X is CO or SO₂ and R¹ to R⁴ are as defined in claim 1.

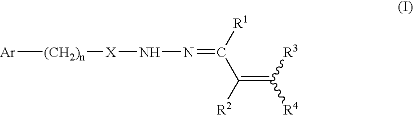

The present invention relates to a method for combating harmful insects and arachnids.

In spite of commercial pesticides for controlling harmful insects and arachnids available today, damage to crops, both growing and harvested, and other nuisance, such as transmission of diseases, caused by insects and arachnids still occur. Therefore, there is continuing need to provide compounds which are useful for combating harmful insects and arachnids.

It is therefore an objective of the present invention to provide compounds which are useful for combating harmful insects and arachnids.

R. J. Cremlyn (J. Chem Soc. C 1967, 77-81) describes that certain sulfanil hydrazides show fungicidal activity.

WO 87/66133 describes acyl hydrazones which are useful for killing internal parasites, such as nematodes, trematodes and cestodes, affecting warm-blooded animals and humans.

U.S. Pat. No. 3,066,023 discloses aroylhydrazones as components of a photoconducting insulating layer in a material for xerography.

WO 99/01423 discloses the preparation of aroylhydrazones which are useful as glucagon antagonists or inverse agonists.

EP-A 322691 discloses aroylhydrazones as precursors for the preparation of 1-acylpyrazolines.

The inventors of the present application surprisingly found that compounds of formula I 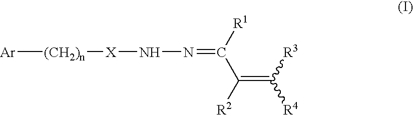
wherein:
Ar is a cyclic radical selected from phenyl, naphthyl and a 5- or 6-membered heterocyclic radical with 1 to 4 heteroatoms which are selected, independently of one another, from O, N and S, where the 5- or 6-membered heterocyclic radical may be fused to 1 or 2 phenyl rings, and where the cyclic radical may have 1, 2, 3, 4 or 5 substituents R^{a} which are selected, independently of one another, from halogen, cyano, nitro, C₁-C₁₀-alkyl, C₁-C₁₀-haloalkyl, C₃-C₁₀-cylcoalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO—, phenyl, benzyl and phenoxy, wherein phenyl, benzyl and phenoxy may be substituted by 1, 2, 3, 4 or 5 substituents R^{b} which are selected, independently of one another, from halogen, cyano, nitro, C₁-C₁₀-alkyl, C₁-C₁₀-haloalkyl, C₃-C₁₀-cylcoalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl; C₁-C₁₀-haloalkylcarbonyl and R⁵R⁶N—CO—;
X is CO or SO₂;
R¹ is H, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₂-C₁₀-haloalkynyl or phenyl which may be substituted by 1 to 5 substituents which are selected, independently of one another, from halogen, cyano, nitro, C₁-C₁₀-alkyl, C₁-C₁₀-haloalkyl, C₃-C₁₀-cylcoalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO—;
R² and R³ are independently of one another H, halogen, cyano, C₁-C₁₀-alkyl, C₁-C₁₀-haloalkyl, C₃-C₁₀-cylcoalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, hydroxy-C₁-C₁₀-alkyl, C₁-C₁₀-alkoxy-C₁-C₁₀-alkyl, halo-C₁-C₁₀-alkoxy-C₁-C₁₀-alkyl, C₁-C₁₀-alkoxycarbonyl-C₁-C₁₀-alkyl, halo-C₁-C₁₀-alkoxycarbonyl-C₁-C₁₀-alkyl or phenyl which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO;
R⁴ is an aromatic radical selected from phenyl, pyridyl, pyrimidyl or furyl, thienyl, where the aromatic radical may carry 1, 2, 3, 4 or 5 substituents R^{c} which are selected, independently of one another, from halogen, cyano, nitro, C₁-C₁₀-alkyl, C₁-C₁₀-haloalkyl, C₃-C₁₀-cylcoalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO— and phenoxy which may be substituted by 1, 2, 3, 4 or 5 substituents R^{d} which are selected, independently of one another, from halogen, cyano, nitro, C₁-C₁₀-alkyl, C₁-C₁₀-haloalkyl, C₃-C₁₀-cylcoalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO; or
R² and R⁴ together with the carbon atoms to which they are bound form a phenyl ring or a 5- or 6-membered heterocyclic ring with 1 or 2 heteroatoms which are selected, independently of one another, from O, N and S, where the phenyl ring and the 5- or 6-membered heterocyclic ring may be fused to a phenyl ring, and where the phenyl ring and the 5- or 6-membered heterocyclic ring and/or the phenyl ring to which they are fused may carry 1, 2, 3 or 4 substituents R^{e}, which are selected, independently of one another, from halogen, cyano, nitro, C₁-C₁₀-alkyl, C₁-C₁₀-haloalkyl, C₃-C₁₀-cylcoalkyl, C₃-C₁₀-halocycloalkyl, C₂-C₁₀-alkenyl, C₂-C₁₀-haloalkenyl, C₂-C₁₀-alkynyl, C₂-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₂-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO and phenoxy which may be substituted by 1, 2, 3, 4 or 5 substituents R^{f} which are selected, independently of one another, from halogen, cyano, nitro, C₁-C₁₀-alkyl, C₁-C₁₀-haloalkyl, C₃-C₁₀-cylcoalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO, and where the 5 or 6-membered heterocyclic ring may contain 1 carbonyl group as a ring member;
R⁵ and R⁶ independently of one another are H or C₁-C₁₀-alkyl; and
n is 0 or 1
   or salts thereof are useful for combating insects and arachnids.

The present invention therefore relates to a method for combating harmful insects and arachnids, which comprises contacting the insects or the arachnids, their habitat, breeding ground, food supply, plant, seed, soil, area, material or environment in which the insects or arachnids grow or may grow, or the materials, plants, seeds, soil, surfaces or spaces to be protected against attack or infestation by insects or arachnids with a pesticidally effective amount of a hydrazone compound of the formula I.

The invention especially relates to a method for protecting crops from attack or infestation by insects or arachnids, which comprises contacting a crop with a pesticidally effective amount of a compound of the formula I as defined above.

Suitable compounds of the general formula I encompass all possible stereoisomers (cis/trans isomers) which may occur and mixtures thereof. Stereoisomeric centers are e.g. the carbon atom of the hydrazone group (N═C) and the carbon atom carrying the radicals R³ and R⁴. Suitable compounds also encompass possible enantiomers and racemic mixtures.

Salts of the compounds of the formula I which are suitable for the use according to the invention are especially agriculturally acceptable salts. They can be formed in a customary method, e.g. by reacting the compound with an acid of the anion in question.

Examples of suitable salts include adducts of compounds I with maleic acid, dimaleic acid, fumaric acid, difumaric acid, methane sulfenic acid, methane sulfonic acid, and succinic acid. Moreover, included as “salts” are those that can form with, for example, amines, metals, alkaline earth metal bases or quaternary ammonium bases, including zwitterions. Suitable metal and alkaline earth metal hydroxides as salt formers include the salts of barium, aluminum, nickel, copper, manganese, cobalt zinc, iron, silver, lithium, sodium, potassium, magnesium or calcium. Additional salt formers include chloride, sulfate, acetate, carbonate, hydride, and hydroxide. Desirable salts include adducts of compounds I with maleic acid, dimaleic acid, fumaric acid, difumaric acid, and methane sulfonic acid.

The term “5- or 6-membered heterocyclic radical with 1 to 4 heteroatoms which are selected, independently of one another, from O, N and S” as used herein refers to both aromatic and non-aromatic rings such as saturated or partially unsaturated radicals having from 1 to 4, preferably 1, 2, or 3 heteroatoms as ring members.

Examples for heteroaromatic rings are triazinyl, pyrazinyl, pyrimidyl, pyridazinyl, pyridyl, thienyl, furyl, pyrrolyl, pyrazolyl, imidazolyl, triazolyl, tetrazolyl, thiazolyl, oxazolyl, thiadiazolyl, oxadiazolyl, isothiazolyl or isoxazolyl.

If the 5- or 6-membered heteroaromatic ring is fused to 1 or 2 phenyl rings, this refers e.g. to quinolinyl, isoquinolinyl, indolyl, indolizinyl, isoindolyl, indazolyl, benzofuryl, benzthienyl, benzthiazolyl, benzoxazolyl, benzimidazolyl, dibenzopyrrolyl, dibenzofuranyl or dibenzothienyl.

Examples for non-aromatic rings are pyrrolidinyl, pyrazolinyl, imidazolinyl, pyrrolinyl, pyrazolinyl, imidazolinyl, tetrahydrofuranyl, dihydrofuranyl, dioxolanyl, dioxolenyl, thiolanyl, dihydrothiophenyl, oxazolidinyl, isoxazolidinyl, oxazolinyl, isoxazolinyl, thiazolinyl, isothiazolinyl, thiazolidinyl, isothiazolidinyl, oxathiolanyl, piperidinyl, piperazinyl, pyranyl, dihydropyranyl, tetrahydropyranyl, dioxanyl, thiopyranyl, dihydrothiopyranyl, tetrahydrothiopyranyl, morpholinyl and thiazinyl.

If the 5- or 6-membered heterocyclic non-aromatic radical is fused to a phenyl group, this refers to e.g. dihydroindolyl, dihydroindolizinyl, dihydroisoindolyl, dihydrochinolinyl, dihydroisochinolinyl, chromenyl, chromanyl and the like.

The term “5- or 6-membered heterocyclic ring with 1 or 2 heteroatoms which are selected, independently of one another, from O, N and S, where the 5- or 6-membered heterocyclic ring may be fused to a phenyl ring” as used herein refers e.g. to pyrazinyl, pyrimidyl, pyridazinyl, pyridyl, thienyl, furyl, pyrrolyl, pyrazolyl, imidazolyl, thiazolyl, oxazolyl, isothiazolyl, isoxazolyl, quinolinyl, isoquinolinyl, indolyl, indazolyl, benzofuryl, benzthienyl, benzthiazolyl, benzoxazolyl, benzimidazolyl or chromenyl and further to the radicals as exemplified for the 5- or 6-membered heterocyclic non-aromatic rings and for the non-aromatic rings fused to a phenyl group.

If the 5- or 6-membered heterocyclic ring with 1 or 2 heteroatoms which may be fused to a phenyl ring contains a carbonyl group as a ring member, this refers to e.g. pyrrolidonyl, pyrazolidonyl, pyrazolonyl, oxazolidonyl, pyridonyl, pyronyl, indoxylyl, oxindolyl, cumarinyl, chromenonyl (chromonyl) and the like.

“Halogen” will be taken to mean fluoro, chloro, bromo and iodo.

The term “C₁-C₁₀-alkyl” as used herein refers to a branched or unbranched saturated hydrocarbon group having 1 to 10 carbon atoms, for example methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4 methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, heptyl, octyl, 2-ethylhexyl, nonyl and decyl and their isomers. C₁-C₄-alkyl means for example methyl, ethyl, propyl, 1-methylethyl, butyl, 1-methylpropyl, 2-methylpropyl or 1,1-dimethylethyl.

The term “C₁-C₁₀-haloalkyl” as used herein refers to a straight-chain or branched alkyl group having 1 to 10 carbon atoms (as mentioned above), where some or all of the hydrogen atoms in these groups may be replaced by halogen atoms as mentioned above, for example C₁-C₄-haloalkyl, such as chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl and the like.

Similarly, “C₁-C₁₀-alkoxy” and “C₁-C₁₀-alkylthio” refer to straight-chain or branched alkyl groups having 1 to 10 carbon atoms (as mentioned above) bonded through oxygen or sulfur linkages, respectively, at any bond in the alkyl group. Examples include C₁-C₄-alkoxy such as methoxy, ethoxy, propoxy, isopropoxy, butoxy, sec-butoxy, isobutoxy and tert-butoxy, further C₁-C₄-alkylthio such as methylthio, ethylthio, propylthio, isopropylthio, and n-butylthio.

Accordingly, the terms “C₁-C₁₀-haloalkoxy” and “C₁-C₁₀-haloalkylthio” refer to straight-chain or branched alkyl groups having 1 to 10 carbon atoms (as mentioned above) bonded through oxygen or sulfur linkages, respectively, at any bond in the alkyl group, where some or all of the hydrogen atoms in these groups may be replaced by halogen atoms as mentioned above, for example C₁-C₂-haloalkoxy, such as chloromethoxy, bromomethoxy, dichloromethoxy, trichloromethoxy, fluoromethoxy, difluoromethoxy, trifluoromethoxy, chlorofluoromethoxy, dichlorofluoromethoxy, chlorodifluoromethoxy, 1-chloroethoxy, 1-bromoethoxy, 1-fluoroethoxy, 2-fluoroethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy and pentafluoroethoxy, further C₁-C₂-haloalkylthio, such as chloromethylthio, bromomethylthio, dichloromethylthio, trichloromethylthio, fluoromethylthio, difluoromethylthio, trifluoromethylthio, chlorofluoromethylthio, dichlorofluoromethylthio, chlorodifluoromethylthio, 1-chloroethylthio, 1-bromoethylthio, 1-fluoroethylthio, 2-fluoroethylthio, 2,2-difluoroethylthio, 2,2,2-trifluoroethylthio, 2-chloro-2-fluoroethylthio, 2-chloro-2,2-difluoroethylthio, 2,2-dichloro-2-fluoroethylthio, 2,2,2-trichloroethylthio and pentafluoroethylthio and the like.

The term “C₂-C₁₀-alkenyl” as used herein intends a branched or unbranched unsaturated hydrocarbon group having 2 to 10 carbon atoms and a double bond in any position, such as ethenyl, 1-propenyl, 2-propenyl, 1-methyl-ethenyl, 1-butenyl, 2-butenyl, 3-butenyl, 1-methyl-1-propenyl, 2-methyl-1-propenyl, 1-methyl-2-propenyl, 2-methyl-2-propenyl; 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and I-ethyl-2-methyl-2-propenyl;

The term “C₂-C₁₀-haloalkenyl” as used herein intends a branched or unbranched unsaturated hydrocarbon group having 2 to 10 carbon atoms and a double bond in any position, where some or all of the hydrogen atoms in these groups may be replaced by halogen atoms as mentioned above.

Similarly, the term “C₂-C₁₀-alkenyloxy” as used herein intends a branched or unbranched unsaturated hydrocarbon group having 2 to 10 carbon atoms and a double bond in any position, the alkenyl group being bonded through oxygen linkages, respectively, at any bond in the alkenyl group, for example ethenyloxy, propenyloxy and the like.

Accordingly, the term “C₂-C₁₀-haloalkenyloxy” as used herein intends a branched or unbranched unsaturated hydrocarbon group having 2 to 10 carbon atoms and a double bond in any position, the alkenyl group being bonded through oxygen linkages, respectively, at any bond in the alkenyl group, where some or all of the hydrogen atoms in these groups may be replaced by halogen atoms as mentioned above.

The term “C₂-C₁₀-alkynyl” as used herein refers to a branched or unbranched unsaturated hydrocarbon group having 2 to 10 carbon atoms and containing at least one triple bond, such as ethynyl, propynyl, 1-butynyl, 2-butynyl, and the like.

The term “C₃-C₁₀-haloalkynyl” as used herein refers to a branched or unbranched unsaturated hydrocarbon group having 3 to 10 carbon atoms and containing at least one triple bond, where some or all of the hydrogen atoms in these groups may be replaced by halogen atoms as mentioned above, with the proviso that the halogen atom is not directly bound to the triple bond.

The term “C₂-C₁₀-alkynyloxy” as used herein refers to a branched or unbranched unsaturated hydrocarbon group having 2 to 10 carbon atoms and containing at least one triple bond, the alkynyl group being bonded through oxygen linkages at any bond in the alkynyl group.

Similarly, the term “C₃-C₁₀-haloalkynyloxy” as used herein refers to a branched or unbranched unsaturated hydrocarbon group having 3 to 10 carbon atoms and containing at least one triple bond, the group being bonded through oxygen linkages at any bond in the alkynyl group, where some or all of the hydrogen atoms in these group may be replaced by halogen atoms as mentioned above, with the proviso that the halogen atom is not directly bound to the triple bond.

The term “C₃-C₁₀-cycloalkyl” as used herein refers to a monocyclic 3- to 10-membered saturated carbon atom ring, e.g. cyclopropyl, cyclobutyl, cyclopentyl, cyclohexyl, cycloheptyl, cyclooctyl and cyclodecyl.

The term “C₃-C₁₀-halocycloalkyl” as used herein refers to a monocyclic 3- to 10-membered saturated carbon atom ring, e.g. cyclopropyl, cyclobutyl, cyclopentyl, cyclohexyl, cycloheptyl, cyclooctyl and cyclodecyl, where some or all of the hydrogen atoms in these groups may be replaced by halogen atoms as mentioned above, for example chloro-, dichloro- and trichlorocyclopropyl, fluoro-, difluoro- and trifluorocyclopropyl, chloro-, dichloro-, trichloro, tetrachloro-, pentachloro- and hexachlorocyclohexyl and the like.

With respect to the use according to the invention of the compounds of formula I, particular preference is given to the following meanings of the substituents, in each case on their own or in combination:

Preference is given to the use of compounds of formula I, wherein
Ar is a cyclic radical selected from phenyl, naphthyl, a 5- or 6-membered heterocyclic radical with 1 to 3 heteroatoms which are selected, independently of one another, from O, N and S, where the 5- or 6-membered heterocyclic radical may be fused to 1 or 2 phenyl rings and where the cyclic radical is unsubstituted or substituted as defined above, i.e. by 1, 2, 3, 4 or 5 of the above mentioned radicals R^{a}.

Particular preference is given to the use of compounds of formula I, wherein
Ar is a cyclic radical selected from phenyl, triazinyl, pyrazinyl, pyrimidyl, pyridazinyl, pyridyl, thienyl, furyl, pyrrolyl, pyrazolyl, imidazolyl, triazolyl, thiazolyl, oxazolyl, thiadiazolyl, oxadiazolyl, isothiazolyl, isoxazolyl, naphthyl, quinolinyl, isoquinolinyl, indolyl, indazolyl, benzofuryl, benzthienyl, benzthiazolyl, benzoxazolyl, benzimidazolyl, chromenyl, chromenonyl, dibenzopyranyl or fluorenyl and where the cyclic radical is unsubstituted or substituted as defined above.

Furthermore, particular preference is given to the use of compounds of formula I, wherein
Ar is a cyclic radical selected from thienyl, furyl, pyrrolyl, pyrazolyl, imidazolyl, triazolyl, oxazolyl, isoxazolyl, oxadiazolyl, thiazolyl, isothiazolyl, thiadiazolyl, phenyl, pyridyl, pyrazinyl, pyrimidyl, pyridazinyl, naphthyl, dibenzopyranyl, indolyl, benzimidazolyl, benzofuryl, benzoxazolyl, benzothienyl, benzthiazolyl or chromenonyl and where the cyclic radical is unsubstituted or substituted by 1, 2, 3, 4 or 5 of the above mentioned radicals R^{a}.

Moreover, particular preference is given to the use of compounds of formula I, wherein
Ar is a cyclic radical selected from thienyl, furyl, pyrazolyl, imidazolyl, isoxazolyl, thiazolyl, thiadiazolyl, phenyl, pyridyl, pyrazinyl, naphthyl, dibenzopyranyl, indolyl or benzothieny and where the cyclic radical is unsubstituted or substituted by 1, 2, 3, 4 or 5 of the above mentioned radicals R^{a}.

Even more particular preference is given to the use of compounds of formula I, wherein
Ar is a cyclic radical selected from thienyl, furyl, pyrazolyl, imidazolyl, isoxazolyl, phenyl, pyridyl, pyrazinyl, naphthyl, indolyl or benzothienyl, especially thienyl, furyl, pyrazolyl, imidazolyl, isoxazolyl, phenyl, pyridyl, pyrazinyl, naphthyl or indolyl and where the cyclic radical is unsubstituted or substituted by 1, 2, 3, 4 or 5 of the above mentioned radicals R^{a}.

Special preference is given to the use of compounds of formula I, wherein
Ar is a cyclic radical selected from thienyl, furyl, pyrazolyl, phenyl, isoxazolyl or pyridyl and where the cyclic radical is unsubstituted or substituted by 1, 2, 3, 4 or 5 of the above mentioned radicals R^{a}. However, compounds, wherein Ar is optionally substituted phenyl are also highly preferred.

Preferably, the cyclic radical mentioned for Ar is unsubstituted or carries 1, 2, 3 or 4 substituents R^{a}, in particular 1, 2 or 3 and more preferably 1 or 2 substituents R^{a}.

Preferred substituents R^{a} are selected, independently of one another, from halogen, cyano, nitro, C₁-C₁₀-alkyl, C₁-C₁₀-haloalkyl, C₃-C₁₀-cylcoalkyl, C₃-C₁₀-halocycloalkyl, C₁-C₁₀-alkoxy, C₁-C₁₀-haloalkoxy, C₁-C₁₀-alkylthio, C₁-C₁₀-haloalkylthio, C₁-C₁₀-alkylsulfonyl, C₁-C₁₀-haloalkylsulfonyl, hydroxy, phenyl, phenoxy, NR⁵R⁶, C₁-C₁₀-alkoxycarbonyl, C₁-C₁₀-haloalkoxycarbonyl, C₁-C₁₀-alkylcarbonyl, C₁-C₁₀-haloalkylcarbonyl and NR⁵R⁶—CO—.

Particularly preferred substituents R^{a} are selected, independently of one another, from halogen, hydroxy, C₁-C₄-alkyl, C₁-C₄-haloalkyl, C₁-C₄-alkoxy, C₁-C₄-haloalkoxy, phenyl, which is unsubstituted or substituted by 1 to 3 substituents R^{b} which are in particular selected, independently of one another, from halogen, C₁-C₄-alkyl, C₁-C₄-haloalkyl and C₁-C₄-alkoxy, especially by halogen, and phenoxy which is unsubstituted or substituted by 1 to 3 substituents R^{b} which are in particular selected, independently of one another, from halogen, C₁-C₄-alkyl, C₁-C₄-haloalkyl and C₁-C₄-alkoxy, especially by C₁-C₄-haloalkyl.

More preferred substituents R^{a} are selected, independently of one another, from halogen, C₁-C₄-alkyl, C₁-C₄-haloalkyl, C₁-C₄-alkoxy and C₁-C₄-haloalkoxy.

Especially preferred substituents R^{a} are selected, independently of one another, from fluorine, chlorine, bromine, C₁-C₄-alkyl, C₁-C₄-alkoxy, in particular methoxy, C₁-C₄-haloalkoxy, in particular difluoromethoxy or trifluoromethoxy and CF₃.

Preference is given to the use of compounds of formula I, wherein
R¹ is H, C₁-C₄-alkyl or C₁-C₄-haloalkyl.

Particular preference is given to the use of compounds of formula I, wherein
R¹ is H or methyl, most preferably H.

Preference is given to the use of compounds of formula I, wherein
R² is H, C₁-C₁₀-alkyl, C₁-C₁₀-haloalkyl, halogen, phenyl or cyano.

Particular preference is given to the use of compounds of formula I, wherein
R² is H, C₁-C₁₀-alkyl, in particular C₁-C₄-alkyl, halogen, phenyl or cyano.

Furthermore, particular preference is given to the use of compounds of formula I, wherein
R² is H, C₁-C₁₀-alkyl, in particular C₁-C₄-alkyl or halogen, e.g. methyl, ethyl, isopropyl, fluorine, chlorine or bromine. Most preferably R² is C₁-C₄-alkyl, in particular methyl or ethyl.

Preference is given to the use of compounds of formula I, wherein
R³ is H, C₁-C₄-alkyl, C₁-C₄-haloalkyl, halogen or phenyl.

Particular preference is given to the use of compounds of formula I, wherein
R³ is H, C₁-C₄-alkyl, halogen or phenyl, especially H or halogen.

Preference is given to the use of compounds of formula I, wherein
R⁴ is an aromatic radical selected from phenyl, pyridyl, pyrimidyl, furanyl, thienyl or benzofuryl where the aromatic radical is unsubstituted or substituted as defined above, i.e. by 1, 2, 3, 4 or 5 of the above mentioned radicals R^{c}.

Particular preference is given to the use of compounds of formula I, wherein
R⁴ is phenyl where phenyl is unsubstituted or substituted as defined above.

The aromatic radical as mentioned for R⁴ may be unsubstituted or may carry 1 to 5, preferably 1 to 4, more preferably 1 to 3 and in particular 1 or 2 substituents R^{c}.

Preferred substituents R^{c} are selected, independently of one another, from hydroxy, halogen, cyano, nitro, C₁-C₁₀-alkyl, C₁-C₁₀-haloalkyl, C₃-C₁₀-cycloalkyl, C₃-C₁₀-halocycloalkyl, C₁-C₁₀-alkoxy, C₁-C₁₀-haloalkoxy, C₁-C₁₀-alkylthio, C₁-C₁₀-haloalkylthio, C₁-C₁₀-alkylsulfonyl, C₁-C₁₀-haloalkylsulfonyl, NR⁵R⁶, C₁-C₁₀-alkoxycarbonyl, C₁-C₁₀-haloalkoxycarbonyl, R⁵R⁶N—CO— and phenoxy which may be substituted by C₁-C₄-haloalkyl.

Particularly preferred substituents R^{c} are selected, independently of one another, from halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, cyano, nitro, NR⁵R⁶ and phenoxy which may be substituted by C₁-C₄-haloalkyl.

More preferred substituents R^{c} are selected, independently of one another, from halogen, C₁-C₄-alkyl, C₁-C₄-haloalkyl, C₁-C₄-alkoxy, C₁-C₄-haloalkoxy and C₁-C₄-haloalkylthio, e.g. from fluorine, chlorine, methyl, ethyl, propyl, isopropyl, butyl, fluoromethyl, difluoromethyl, trifluoromethyl, methoxy, difluoromethoxy, trifluoromethoxy and trifluoromethylthio.

Especially preferred substituents R^{c} are selected, independently of one another, from halogen, C₁-C₄-alkyl and C₁-C₄-haloalkyl.

If R⁴ is phenyl, which carries 1, 2 or 3 of the aforementioned substituents R^{c}, then at least one of the substituents is preferably located in the 2, 4 and/or 6-position. Examples of particularly preferred substituted phenyl are those mentioned in tables 2 and 3 as radicals R⁴.

Alternatively, preference is given to the use of compounds of formula I, wherein R² and R⁴ together with the carbon atoms to which they are bound form a phenyl ring or a 5- or 6-membered heterocyclic ring with 1 or 2 heteroatoms which are selected, independently of one another, from O, N and S, where the 5- or 6-membered heterocyclic ring may be fused to a phenyl ring, and where the 5- or 6-membered heterocyclic ring and/or the phenyl ring to which it is fused may carry 1, 2, 3 or 4 of the aforementioned substituents R^{e}. Preferably, the substituents R^{e} are selected, independently of one another, from halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, cyano, nitro, phenyl, which is unsubstituted or is substituted by 1, 2 or 3 substituents R^{f} which are selected, independently of one another, from C₁-C₄-alkyl, C₁-C₄-haloalklyl C₁-C₄-alkoxy and halogen, and phenoxy which is unsubstituted or substituted by 1 to 3 substituents which are selected, independently of one another, from C₁-C₄-alkyl, C₁-C₄-haloalklyl, C₁-C₄-alkoxy and halogen, and where the 5- or 6-membered heterocyclic ring may contain 1 carbonyl group as a ring member.

In this alternative, particular preference is given to the use of compounds of formula I, wherein R² and R⁴ together with the carbon atoms to which they are bound form a phenyl, benzofuranyl, benzothienyl, indolyl, chromenyl, chromenonyl, pyrazolyl or furanyl moiety, and where the moiety may carry 1, 2, 3 or 4 substituents of the aforementioned substituents R^{e}.

Furthermore, particular preference is given to the use of compounds of formula I, wherein R² and R⁴ together with the carbon atoms to which they are bound form a phenyl, benzofuranyl, benzothienyl or chromenyl moiety, and where the moiety may be substituted by 1, 2 or 3 substituents R^{e}.

Even more preference is given to the use of compounds of formula I, wherein R² and R⁴ together with the carbon atoms to which they are bound form a benzofuranyl or benzothienyl moiety.

In this alternative, R³ is either H or is one of the above-mentioned substituents of the moiety formed by R² and R⁴ together with the carbon atoms to which they are bound.

In particular substituents R^{e} are selected, independently of one another, from halogen, C₁-C₄-alkyl, C₁-C₄-haloalkyl, C₁-C₄-haloalkoxy, C₁-C₄-haloalkylthio, cyano, nitro, phenyl, which is unsubstituted or is substituted by 1, 2 or 3 substituents which are selected, independently of one another, from C₁-C₄-haloalklyl and halogen, and phenoxy which is unsubstituted or substituted by C₁-C₄-haloalklyl. Preferably, the substituents R^{e} are selected, independently of one another, from halogen, C₁-C₄-alkyl, C₁-C₄-haloalkyl, C₁-C₄-alkoxy, C₁-C₄-haloalkoxy, C₁-C₄-haloalkylthio, cyano and nitro. More preferably substituents R^{e} are selected, independently of one another, from C₁-C₄-alkyl, C₁-C₄-haloalkyl and halogen.

Particularly preferred radicals R^{b}, R^{d} and R^{f} are selected from halogen, C₁-C₄-alkyl, C₁-C₄-haloalkyl, C₁-C₄-haloalkoxy, C₁-C₄-haloalkylthio, cyano and nitro, especially from halogen, C₁-C₄-alkyl, C₁-C₄-alkoxy, C₁-C₄-haloalkyl, C₁-C₄-haloalkoxy.

A very preferred embodiment of the invention relates to the use of pyridyl compounds of the general formula Ia 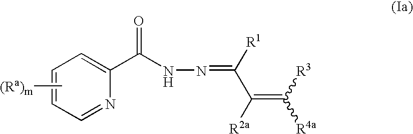
wherein R^{a}, R¹ and R³ are as defined herein,
m is 0, 1, 2 or 3,
R^{a} is H or C₁-C₄ alkyl and
R^{4a} is phenyl, which may carry 1, 2, 3 or 4 substituents R^{c} as defined herein,

In case R^{2a} is C₁-C₄ alkyl and additionally one of the following provisions i) to iv) are met, the compounds Ia are new and thus are part of the present invention:
i) m is not 0 or
ii) R^{4a} carries at least one substituent R^{c} being different from hydrogen
iii) or R¹ is different from hydrogen,
iv) or R^{2a} is different from methyl.

In formula Ia preference is given to compounds wherein m is 0, 1 or 2.

Preferably R^{a} in formula Ia has one of the meanings which are indicated as being preferred, more preferred, particularly preferred or especially preferred. Most preferably R^{a} is Halogen, in particular F, Cl or Br, C₁-C₄-alkyl, in particular methyl or ethyl, phenyl, difluoromethyl, trifluoromethyl or C₁-C₄-alkoxy, in particular methoxy.

Amongst the compounds of the formula Ia those are preferred wherein R¹ and R³ have, independently of each other, one of the meanings which are indicated as being preferred, more preferred, particularly preferred or especially preferred. Most preferred are compounds Ia, wherein R¹ and R³ are hydrogen.

Preferably, the substituent R^{c}, if present, has one of the meanings which are indicated as being preferred, more preferred, particularly preferred or especially preferred. In particular R^{c} is selected from F, Cl, methoxy or methyl. In particular substituted phenyl is selected from one of the meanings given for R⁴ in tables 3 or 4, in particular from 2-fluorophenyl, 3-fluorophenyl, 4-fluorophenyl, 2,4-difluorophenyl, 3,4-difluorophenyl, 3,5-difluorophenyl, 2,6-difluorophenyl, 2,4,6-trifluorophenyl, 2-chlorophenyl, 3-chlorophenyl, 3,5-dichlorophenyl, 2,6-dichlorophenyl, 4-chlorophenyl, 2-fluoro-chlorophenyl, 3-fluoro-4-trifluoromethylphenyl, 3,4,5-trifluorophenyl, 2-trifluoromethoxyphenyl, 3-trifluoromethoxyphenyl, 4-trifluoromethoxyphenyl, 2-trifluoromethylphenyl, 3-trifluoromethylphenyl, 4-trifluoromethylphenyl, 2-difluoromethoxyphenyl, 3-difluoromethoxyphenyl, 4-difluoromethoxyphenyl. However, compounds Ia, wherein R^{4a} is unsubstituted phenyl, are also highly preferred.

In formula Ia R^{2a} is most preferably methyl or ethyl.

Another very preferred embodiment of the invention relates to the use of isoxazol compounds of the general formula Ib 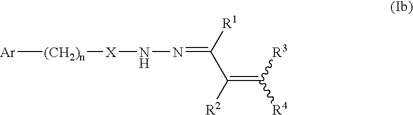
wherein n, X, R¹, R², R³ and R⁴ are as defined herein, and
Ar is isoxazolyl, which may carry 1 or 2 substituents R^{a} as defined herein.

Provided that Ar does not carry an optionally substituted phenyl group as a radical R^{a} if Ar is substituted 4-isoxazolyl these compounds are new and are also part of the present invention.

Amongst the compounds of the formula Ib those are preferred wherein n, X, R^{a}, R¹, R², R³ and R⁴ have, independently of each other, one of the meanings which are indicated as being preferred, more preferred, particularly preferred or especially preferred. In particular the variables R¹, R², R³ and R^{a} have the meanings outlined below:
R¹ is H,
R² is H or C₁-C₄ alkyl most preferably methyl or ethyl,
R³ is H and
R⁴ is phenyl, which may carry 1, 2, 3 or 4 substituents R^{c} as defined herein,

Preferably, the substituent R^{c}, if present, has one of the meanings which are indicated as being preferred, more preferred, particularly preferred or especially preferred. In particular R^{c} is selected from F, Cl, methoxy or methyl. In particular substituted phenyl is selected from one of the meanings given for R⁴ in tables 3 or 4, in particular from 2-fluorophenyl, 3-fluorophenyl, 4-fluorophenyl, 2,4-difluorophenyl, 3,4-difluorophenyl, 3,5-difluorophenyl, 2,6-difluorophenyl, 2,4,6-trifluorophenyl, 2-chlorophenyl, 3-chlorophenyl, 3,5-dichlorophenyl, 2,6-dichlorophenyl, 4-chlorophenyl, 2-fluoro-4-chlorophenyl, 3-fluoro-4-trifluoromethylphenyl, 3,4,5-trifluorophenyl, 2-trifluoromethoxyphenyl, 3-trifluoromethoxyphenyl, 4-trifluoromethoxyphenyl, 2-trifluoromethylphenyl, 3-trifluoromethylphenyl, 4-trifluoromethylphenyl, 2-difluoromethoxyphenyl, 3-difluoromethoxyphenyl, 4-difluoromethoxyphenyl. However, compounds Ia, wherein R⁴ is unsubstituted phenyl, are also highly preferred.

In formula Ib X is preferably C═O and n is preferably 0.

Another very preferred embodiment of the invention relates to the use of pyrazol compounds of the general formula Ic 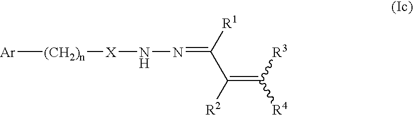
wherein n, X, R¹, R², R³ and R⁴ are as defined in claim 1,
Ar is pyrazolyl which carries a substituent R^{a2} on the pyrazol nitrogen atom, and which may additionally carry 1 or 2 substituents R^{a} as defined in claim 1, wherein R^{a2} is selected from C₁-C₁₀-alkyl, C₁-C₁₀-haloalkyl, C₃-C₁₀-cylcoalkyl, C₃-C₁₀-halocycloalkyl, C₂-C₁₀-alkenyl, C₂-C₁₀-haloalkenyl, C₂-C₁₀alkynyl, C₃-C₁₀-haloalkynyl, phenyl and benzyl, wherein phenyl and benzyl may be unsubstituted or substituted by 1, 2, 3, 4 or 5 substituents R^{b} as defined in claim 1

The compounds of the formula Ic are new and thus are also part of the present invention.

Amongst the compounds of the formula Ic those are preferred wherein n, X, R^{a}, R^{b}, R¹, R², R³ and R⁴ have, independently of each other, one of the meanings which are indicated as being preferred, more preferred, particularly preferred or especially preferred.

R^{a2} is preferably selected from C₁-C₆-alkyl, C₃-C₆-cycloalkyl or phenyl. In a particularly preferred embodiment R^{a2} is C₁-C₄-alkyl.

In particular the variables R¹, R², R³ and R⁴ have the meanings outlined below:
R¹ is H,
R² is H or C₁-C₄ alkyl most preferably methyl or ethyl,
R³ is H, and
R⁴ is phenyl, which may carry 1, 2, 3 or 4 substituents R^{c} as defined herein,

Preferably, the substituent R^{c}, if present, has one of the meanings which are indicated as being preferred, more preferred, particularly preferred or especially preferred. In particular R^{c} is selected from F, Cl, methoxy or methyl. In particular substituted phenyl is selected from one of the meanings given for R⁴ in tables 3 or 4, in particular from 2-fluorophenyl, 3-fluorophenyl, 4-fluorophenyl, 2,4-difluorophenyl, 3,4-difluorophenyl, 3,5-difluorophenyl, 2,6-difluorophenyl, 2,4,6-trifluorophenyl, 2-chlorophenyl, 3-chlorophenyl, 3,5-dichlorophenyl, 2,6-dichlorophenyl, 4-chlorophenyl, 2-fluoro-chlorophenyl, 3-fluoro-4-trifluoromethylphenyl, 3,4,5-trifluorophenyl, 2-trifluoromethoxyphenyl, 3-trifluoromethoxyphenyl, 4-trifluoromethoxyphenyl, 2-trifluoromethylphenyl, 3-trifluoromethylphenyl, 4-trifluoromethylphenyl, 2-difluoromethoxyphenyl, 3-difluoromethoxyphenyl, 4-difluoromethoxyphenyl. However, compounds Ia, wherein R⁴ is unsubstituted phenyl, are also highly preferred.

In formula Ic X is preferably C═O and n is preferably 0.

A very preferred embodiment of the invention relates to the use of phenyl compounds of the general formula Id 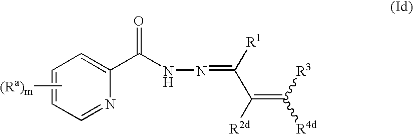
wherein R^{a}, R¹ and R³ are as defined herein,
m is 1, 2 or 3,
R^{2d} is H or C₁-C₄ alkyl and
R^{4d} is phenyl, which may carry 1, 2, 3 or 4 substituents R^{c} as defined herein,

In formula Id preference is given to compounds wherein m is 1 or 2.

Preferably R^{a} in formula Id has one of the meanings which are indicated as being preferred, more preferred, particularly preferred or especially preferred. Most preferably R^{a} is Halogen, in particular F, Cl or Br, C₁-C₄-alkyl, in particular methyl or ethyl, phenyl, difluoromethyl, trifluoromethyl or C₁-C₄-alkoxy, in particular methoxy. Most preferably at least one radical R^{a} is halogen, especially fluorine.

Amongst the compounds of the formula Id those are preferred wherein R¹ and R³ have, independently of each other, one of the meanings which are indicated as being preferred, more preferred, particularly preferred or especially preferred. Most preferred are compounds Ia, wherein R¹ and R³ are hydrogen.

Preferably, the substituent R^{c}, if present, has one of the meanings which are indicated as being preferred, more preferred, particularly preferred or especially preferred. In particular R^{c} is selected from F, Cl, methoxy or methyl. In particular substituted phenyl is selected from one of the meanings given for R⁴ in tables 3 or 4, in particular from 2-fluorophenyl, 3-fluorophenyl, 4-fluorophenyl, 2,4-difluorophenyl, 3,4-difluorophenyl, 3,5-difluorophenyl, 2,6-difluorophenyl, 2,4,6-trifluorophenyl, 2-chlorophenyl, 3-chlorophenyl, 3,5-dichlorophenyl, 2,6-dichlorophenyl, 4-chlorophenyl, 2-fluoro-chlorophenyl, 3-fluoro-4-trifluoromethylphenyl, 3,4,5-trifluorophenyl, 2-trifluoromethoxyphenyl, 3-trifluoromethoxyphenyl, 4-trifluoromethoxyphenyl, 2-trifluoromethylphenyl, 3-trifluoromethylphenyl, 4-trifluoromethylphenyl, 2-difluoromethoxyphenyl, 3-difluoromethoxyphenyl, 4-difluoromethoxyphenyl.

In formula Id R^{2d} is most preferably methyl or ethyl.

As far as the specific stereoisomers are concerned, preference is given to the use of compounds of formula I wherein the conformation at the C/N double bond is E. Preference is also given to the use of mixture of E/Z isomers referring to the C/N double bond, wherein the E isomer is predominating.

Preference is further given to the use of compounds of formula I wherein R² and R⁴ are bound cis to each other. Preference is also given to mixtures of the cis/trans isomers, referring to the position of R² and R⁴ towards each other, wherein the cis isomer is predominating.

The compounds of the formula I may be readily synthesized using techniques generally known by synthetic organic chemists. Exemplary synthesis methods are described for example in WO 87/06133.

For instance, suitable acyl hydrazides can be reacted with aldehydes or ketones to form acyl hydrazones:

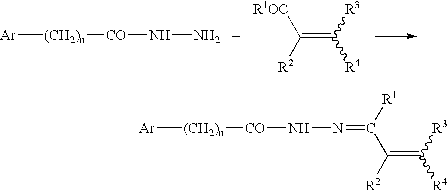

Cinnamic aldehydes and analogous ketones can be obtained according to a literature procedure (Organikum, Johann Ambrosius Barth Verlag, Heidelberg, 1996, pp. 493-495) from benzaldehydes and aliphatic ketones or aldehydes.

The sulfonyl hydrazones (X═SO₂) can be obtained in an analogous way starting from the corresponding sulfonic acid hydrazides (e.g. Munshi, Shah, Trivedi, Indian J. Chem. 1963, 1, 318-320):

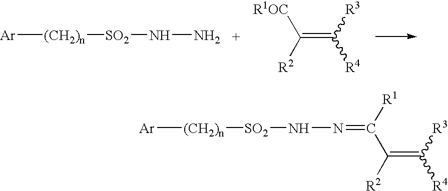

If not commercially available, the starting materials (acyl hydrazides) can be prepared according to literature procedures (e.g. Khan, Siddiqui, Bhatt, Oriental Journal of Chemistry 2002, 18, 163-164) e.g. from carboxylic acid esters (Ar—(CH₂)ₙ—COOR^{a}) or other acid derivatives such as Ar—(CH₂)ₙ—COY (Y=halogen) which are reacted with hydrazine to form the corresponding acyl hydrazides. Alternatively, carboxylic acids (Ar—(CH₂)ₙ—COOH) can be reacted with protected hydrazine in the presence of a coupling reagent such as DCC or DIC (according to Guan, Green, Bergstrom, J. Comb. Chem. 2000, 2, 297-300), and subsequent removal of the protecting group (Messina, Botta, Corelli, Paladino, Tetrahedron Asymm. 2000, 11, 4895-4901; Greene, Wuts, Protective Groups in Organic Synthesis, 2nd edition, 1991, pp. 309):
Ar—(CH₂)ₙ—COOR^{a}+NH₂—NH₂→Ar—(CH₂)ₙ—CO—NH—NH₂
Ar—(CH₂)ₙ—COOH+NH₂—NHP*→Ar—(CH₂)ₙ—CO—NH—NHP*→Ar—(CH₂)ₙ—CO—NH—NH₂
*P=protective group; R^{a}=C₁-C₁₀-alkyl

The sulfonyl hydrazides (X═SO₂) can be obtained in an analogous way starting from the corresponding sulfonic acid derivatives, e.g. from the corresponding sulfonic acid (Ar—(CH₂)ₙ—SO₂OH) or another derivative such as the sulfonic acid halogenide (Ar—(CH₂)ₙ—SO₂Y; Y=halogen): (e.g. El-Maghrabi, Mohamed, J. Chem. Tech. Biotechnol. 1983, 33A, 25-32)
Ar—(CH₂)ₙ—SO₂OH+NH₂—NHP*→Ar—(CH₂)ₙ—SO₂—NH—NHP*→Ar—(CH₂)ₙ—SO₂—NH—NH₂
*P=protective group; R^{a}=C₁-C₁₀-alkyl

If individual compounds I are not obtainable by the route described above, they can be prepared by derivatization of other compounds I or by customary modifications of the synthesis routes described.

The preparation of the compounds of formula I may lead to them being obtained as isomer mixtures (stereoisomers, enantiomers). If desired, these can be resolved by the methods customary for this purpose, such as crystallization or chromatography, also on optically active adsorbate, to give the pure isomers.

According to the present invention, the compounds of the general formula I are used for controlling harmful insects and arachnids. In particular, they are used for controlling the following animal pests:

insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Chematobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella; Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera eridania, Spodoptera frugiperda, Spodoptera littoralis, Spodoptera litura, Thaumatopoea pityocampa, Tortrix viridana, Trichoplusia ni and Zeiraphera canadensis,

beetles (Coleoptera), for example Agrilus sinuatus, Agriotes lineatus, Agriotes obscurus, Amphimallus solstitialis, Anisandrus dispar, Anthonomus grandis, Anthonomus pomorum, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus, Crioceris asparagi, Diabrotica longicornis, Diabrotica 12-punctata, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllotreta chrysocephala, Phyllophaga sp., Phyllopertha horticola, Phyllotreta nemorum, Phyllotreta striolata, Popillia japonica, Sitona lineatus and Sitophilus granaria,

dipterans (Diptera), for example Aedes aegypti, Aedes vexans, Anastrepha ludens, Anopheles maculipennis, Ceratitis capitata, Chrysomya bezziana, Chrysomya hominivorax, Chrysomya macellaria, Contarinia sorghicola, Cordylobia anthropophaga, Culex pipiens, Dacus cucurbitae, Dacus oleae, Dasineura brassicae, Fannie canicularis, Gasterophilus intestinalis, Glossina morsitans, Haematobia irritans, Haplodiplosis equestris, Hylemyia platura, Hypoderma lineata, Liriomyza sativae, Liriomyza trifoli, Lucilia caprina, Lucilia cuprina, Lucilia sericata, Lycoria pectoralis, Mayetiola destructor, Musca domestica, Muscina stabulans, Oestrus ovis, Oscinella frit, Pegomya hysocyami, Phorbia antiqua, Phorbia brassicae, Phorbia coarctata, Rhagoletis cerasi, Rhagoletis pomonella, Tabanus bovinus, Tipula oleracea and Tipula paludosa,

thrips (Thysanoptera), e.g. Dichromothrips corbetti, Frankliniella fusca, Frankliniella occidentalis, Frankliniella tritici, Scirtothrips citri, Thrips oryzae, Thrips palmi and Thrips tabaci,

hymenopterans (Hymenoptera), e.g. Athalia rosae, Atta cephalotes, Atta sexdens, Atta texana, Hoplocampa minuta, Hoplocampa testudinea, Monomorium pharaonis, Solenopsis geminata and Solenopsis invicta,

heteropterans (Heteroptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Plesma quadrata, Solubea insularis and Thyanta perditor,

homopterans (Homoptera), e.g. Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Bemisia argentifolii, Brachycaudus cardui, Brachycaudus helichrysi, Brachycaudus persicae, Brachycaudus prunicola, Brevicoryne brassicae, Capitophorus homi, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus persicae, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, and Viteus vitifolii.

termites (Isoptera), e.g. Calotermes flavicollis, Leucotermes flavipes, Reticulitermes lucifugus and Termes natalensis,

orthopterans (Orthoptera), e.g. Acheta domestica, Blatta orientalis, Blattella germanica, Forficula auricularia, Gryllotalpa gryllotalpa, Locusta migratoria, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus,

Arachnoidea, such as arachnids (Acarina), e.g. of the families Argasidae, Ixodidae and Sarcoptidae, such as Amblyomma americanum, Amblyomma variegatum, Argas persicus, Boophilus annulatus, Boophilus decoloratus, Boophilus microplus, Dermacentor silvarum, Hyalomma truncatum, Ixodes ricinus, Ixodes rubicundus, Ornithodorus moubata, Otoblus megnini, Dermanyssus gallinae, Psoroptes ovis, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzewai, Tetranychus pacificus, Tetranychus telarius and Tetranychus urticae, Panonychus ulmi, Panonychus citri, and oligonychus pratensis.

The compounds of the formula I are preferably used for controlling pests of the orders Lepidoptera, Thysanoptera, Homoptera and Acarina and more preferably for controlling insects of the orders Lepidoptera and Homoptera.

The compounds of formula (I) may be used to protect growing plants and crops from attack or infestation by insects or arachnids by contacting the plant/crop with a pesticidally effective amount of compounds of formula (I). The term “crop” refers both to growing and harvested crops.

The insect, arachnid, plant and/or soil or water in which the plant is growing can be contacted with the present compound(s) I or composition(s) containing them by any application method known in the art. As such, “contacting” includes both direct contact (applying the compounds/compositions directly on the insect, arachnid, and/or plant—typically to the foliage, stem or roots of the plant) and indirect contact (applying the compounds/compositions to the locus of the insect, arachnid, and/or plant).

Moreover, insects or arachnids may be controlled by contacting the target pest, its food supply or its locus with a pesticidally effective amount of compounds of formula (I). As such, the application may be carried out before or after the infection of the locus, growing crops, or harvested crops by the pest.

“Locus” means a habitat, breeding ground, plant, seed, soil, area, material or environment in which a pest or parasite is growing or may grow.

In general, for use in treating crop plants, the rate of application of the compounds and/or compositions of this invention may be in the range of about 0.1 g to about 4000 g per hectare, desirably from about 25 g to about 600 g per hectare, more desirably from about 50 g to about 500 g per hectare. For use in treating seeds, the typical rate of application is of from about 1 g to about 500 g per kilogram of seeds, desirably from about 2 g to about 300 g per kilogram of seeds, more desirably from about 10 g to about 200 g per kilogram of seeds. Customary application rates in the protection of materials are, for example, from about 0.001 g to about 2000 g, desirably from about 0.005 g to about 1000 g, of active compound per cubic meter of treated material.

The compounds I can be converted into the customary formulations, e.g. solutions, emulsions, microemulsions, suspensions, flowable concentrates, dusts, powders, pastes and granules. The use form depends on the particular purpose; in any case, it should guarantee a fine and uniform distribution of the compound according to the invention.

The formulations are prepared in a known manner, e.g. by extending the active ingredient with solvents and/or carriers, if desired using emulsifiers and dispersants, it also being possible to use other organic solvents as auxiliary solvents if water is used as the diluent. Auxiliaries which are suitable are essentially: solvents such as aromatics (e.g. xylene), chlorinated aromatics (e.g. chlorobenzenes), paraffins (e.g. mineral oil fractions), alcohols (e.g. methanol, butanol), ketones (e.g. cyclohexanone), amines (e.g. ethanolamine, dimethylformamide) and water, carriers such as ground natural minerals (e.g. kaolins, clays, talc, chalk) and ground synthetic minerals (e.g. highly-disperse silica, silicates); emulsifiers such as non-ionic and anionic emulsifiers (e.g. polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates and fatty acids and their alkali metal and alkaline earth metal salts, salts of sulfated fatty alcohol glycol ether, condensates of sulfonated naphthalene and naphthalene derivatives with formaldehyde, condensates of naphthalene or of napthalenesulfonic acid with phenol or formaldehyde, polyoxyethylene octylphenyl ether, ethoxylated isooctylphenol, octylphenol, nonylphenol, alkylphenol polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, e.g. benzene, toluene, xylene, paraffin, tetrahydronaphthalene, alkylated naphthalenes or their derivatives, methanol, ethanol, propanol, butanol, chloroform, carbon tetrachloride, cyclohexanol, cyclohexanone, chlorobenzene, isophorone, strongly polar solvents, e.g. dimethylformamide, dimethyl sulfoxide, N-methylpyrrolidone and water.

Powders, materials for scattering and dusts can be prepared by mixing or concomitantly grinding the active substances with a solid carrier.

Granules, e.g. coated granules, compacted granules, impregnated granules and homogeneous granules, can be prepared by binding the active ingredients to solid carriers. Examples of solid carriers are mineral earths, such as silicas, silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, e.g. ammonium sulfate, ammonium phosphate, ammonium nitrate, ureas, and products of vegetable origin, such as cereal meal, tree bark meal, wood meal and nutshell meal, cellulose powders and other solid carriers.

Such formulations or compositions of the present invention include a formula I compound of this invention (or combinations thereof) admixed with one or more agronomically acceptable inert, solid or liquid carriers. Those compositions contain a pesticidally effective amount of said compound or compounds, which amount may vary depending upon the particular compound, target pest, and method of use.

In general, the formulations comprise of from 0.01 to 95% by weight, preferably from 0.1 to 90% by weight, of the active ingredient. The active ingredients are employed in a purity of from 90% to 100%, preferably 95% to 100% (according to NMR spectrum).

The following are exemplary formulations:

I. 5 parts by weight of a compound according to the invention are mixed intimately with 95 parts by weight of finely divided kaolin. This gives a dust which comprises 5% by weight of the active ingredient.

II. 30 parts by weight of a compound of formula I are mixed intimately with a mixture of 92 parts by weight of pulverulent silica gel and 8 parts by weight of paraffin oil which had been sprayed onto the surface of this silica gel. This gives a formulation of the active ingredient with good adhesion properties (comprises 23% by weight of active ingredient).

III. 10 parts by weight of a compound of formula I are dissolved in a mixture composed of 90 parts by weight of xylene, 6 parts by weight of the adduct of 8 to 10 mol of ethylene oxide and 1 mol of oleic acid N-monoethanolamide, 2 parts by weight of calcium dodecylbenzenesulfonate and 2 parts by weight of the adduct of 40 mol of ethylene oxide and 1 mol of castor oil (comprises 9% by weight of active ingredient).

IV. 20 parts by weight of a compound of formula I are dissolved in a mixture composed of 60 parts by weight of cyclohexanone, 30 parts by weight of isobutanol, 5 parts by weight of the adduct of 7 mol of ethylene oxide and 1 mol of isooctylphenol and 5 parts by weight of the adduct of 40 mol of ethylene oxide and 1 mol of castor oil (comprises 16% by weight of active ingredient).

V. 80 parts by weight of a compound of formula I are mixed thoroughly with 3 parts by weight of sodium diisobutylnaphthalene-alpha-sulfonate, 10 parts by weight of the sodium salt of a lignosulfonic acid from a sulfite waste liquor and 7 parts by weight of pulverulent silica gel, and the mixture is ground in a hammer mill (comprises 80% by weight of active ingredient).

VI. 90 parts by weight of a compound of formula I are mixed with 10 parts by weight of N-methyl-a-pyrrolidone, which gives a solution which is suitable for use in the form of microdrops (comprises 90% by weight of active ingredient).

VII. 20 parts by weight of a compound of formula I are dissolved in a mixture composed of 40 parts by weight of cyclohexanone, 30 parts by weight of isobutanol, 20 parts by weight of the adduct of 7 mol of ethylene oxide and 1 mol of isooctylphenol and 10 parts by weight of the adduct of 40 mol of ethylene oxide and 1 mol of castor oil. Pouring the solution into 100000 parts by weight of water and finely distributing it therein gives an aqueous dispersion which comprises 0.02% by weight of the active ingredient.

VIII. 20 parts by weight of a compound of formula I are mixed thoroughly with 3 parts by weight of sodium diisobutylnaphthalene-a-sulfonate, 17 parts by weight of the sodium salt of a lignosulfonic acid from a sulfite waste liquor and 60 parts by weight of pulverulent silica gel, and the mixture is ground in, a hammer mill. Finely distributing the mixture in 20000 parts by weight of water gives a spray mixture which comprises 0.1% by weight of the active ingredient.

The active ingredients can be used as such, in the form of their formulations or the use forms prepared therefrom, e.g. in the form of directly sprayable solutions, powders, suspensions or dispersions, emulsions, oil dispersions, pastes, dusts, materials for spreading, or granules, by means of spraying, atomizing, dusting, scattering or pouring. The use forms depend entirely on the intended purposes; in any case, this is intended to guarantee the finest possible distribution of the active ingredients according to the invention.

Aqueous use forms can be prepared from emulsion concentrates, pastes or wettable powders (sprayable powders, oil dispersions) by adding water. To prepare emulsions, pastes or oil dispersions, the substances as such or dissolved in an oil or solvent, can be homogenized in water by means of wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active ingredient concentrations in the ready-to-use products can be varied within substantial ranges. In general, they are from 0.0001 to 10%, preferably from 0.01 to 1%.

The active ingredients may also be used successfully in the ultra-low-volume process (ULV), it being possible to apply formulations comprising over 95% by weight of active ingredient, or even the active ingredient without additives.

Compositions to be used according to this invention may also contain other active ingredients, for example other pesticides, insecticides, herbicides, fertilizers such as ammonium nitrate, urea, potash, and superphosphate, phytotoxicants and plant growth regulators, safeners and nematicides. These additional ingredients may be used sequentially or in combination with the above-described compositions, if appropriate also added only immediately prior to use (tank mix). For example, the plant(s) may be sprayed with a composition of this invention either before or after being treated with other active ingredients.

These agents can be admixed with the agents used according to the invention in a weight ratio of 1:10 to 10:1. Mixing the compounds I or the compositions comprising them in the use form as pesticides with other pesticides frequently results in a broader pesticidal spectrum of action.

The following list of pesticides together with which the compounds of formula I can be used, is intended to illustrate the possible combinations, but not to impose any limitation:

Organophosphates: Acephate, Azinphos-methyl, Chlorpyrifos, Chlorfenvinphos, Diazinon, Dichlorvos, Dicrotophos, Dimethoate, Disulfoton, Ethion, Fenitrothion, Fenthion, Isoxathion, Malathion, Methamidophos, Methidathion, Methyl-Parathion, Mevinphos, Monocrotophos, Oxydemeton-methyl, Paraoxon, Parathion, Phenthoate, Phosalone, Phosmet, Phosphamidon, Phorate, Phoxim, Pirimiphos-methyl, Profenofos, Prothiofos, Sulprophos, Triaophos, Trichlorfon;

Carbamates: Alanycarb, Benfuracarb, Carbaryl, Carbosulfan, Fenoxycarb, Furathiocarb, Indoxacarb, Methiocarb, Methomyl, Oxamyl, Pirimicarb, Propoxur, Thiodicarb, Triazamate;

Pyrethroids: Bifenthrin, Cyfluthrin, Cypermethrin, Deltamethrin, Esfenvalerate, Ethofenprox, Fenpropathrin, Fenvalerate, Cyhalothrin, Lambda-Cyhalothrin, Permethrin, Silafluofen, Tau-Fluvalinate, Tefluthrin, Tralomethrin, Zeta-Cypermethrin;

Arthropod growth regulators: a) chitin synthesis inhibitors: benzoylureas: Chlorfluazuron, Diflubenzuron, Flucycloxuron, Flufenoxuron, Hexaflumuron, Lufenuron, Novaluron, Teflubenzuron, Triflumuron; Buprofezin, Diofenolan, Hexythiazox, Etoxazole, Clofentazine; b) ecdysone antagonists: Halofenozide, Methoxyfenozide, Tebufenozide; c) juvenoids: Pyriproxyfen, Methoprene, Fenoxycarb; d) lipid biosynthesis inhibitors: Spirodiclofen;

Various: Abamectin, Acequinocyl, Amitraz, Azadirachtin, Bifenazate, Cartap, Chlorfenapyr, Chlordimeform, Cyromazine, Diafenthiuron, Dinetofuran, Diofenolan, Emamectin, Endosulfan, Ethiprole, Fenazaquin, Fipronil, Formetanate, Formetanate hydrochloride, Hydramethylnon, Imidacloprid, Indoxacarb, Pyridaben, Pymetrozine, Spinosad, Sulfur, Tebufenpyrad, Thiamethoxam, and Thiocyclam.

The present invention is now illustrated in further detail by the following examples.

### 1. SYNTHESIS EXAMPLES

1.1 Preparation of the Starting Materials

The products were characterized by coupled High Performance Liquid Chromatography/mass spectrometry (HPLC/MS), by NMR or by their melting points.

HPLC column: RP-18 column (Chromolith Speed ROD from Merck KgaA, Germany).

Elution: acetonitrile+0.1% trifluoroacetic acid (TFA)/water+0.1% TFA in a ratio of from 5:95 to 95:5 in 5 minutes at 40° C.

MS: Quadrupol electrospray ionisation, 80 V (positiv modus)

1.1.1 Preparation of 4-methylthiophene Carboxylic Acid Hydrazide

A mixture of 142.2 mg (1 mmol) 4-methylthiophene carboxylic acid, 158.6 mg (1.2 mmol) Boc-protected hydrazine and 518 mg (1 mmol) N-cyclohexyl-N′-methyl-polystyrene carbodiimide in 8 ml dichloromethane was stirred at room temperature overnight. After filtration, 400 mg 4-benzyloxybenzaldehyde polystyrene were added and stirred overnight. After filtration and evaporation of the solvent, 130 mg (0.51 mmol, 51%) of Boc-protected acyl hydrazide were obtained (retention time (RT)=2.339 min, m/z=279 [M+Na]⁺). Subsequently, 3 ml of trifluoroacetic acid/dichloromethane 1:1 were added. After 2 h the solvent was removed in vacuo and water was added. The product was isolated by extraction with dichlormethane (3 times) and removal of the solvent. Purity was sufficient for further reactions (RT=1.132 min, m/z=157 [M+H]⁺).

1.2 Preparation of the Final Hydrazones of Formula I

1.2.1 Preparation of furan-2-carboxylic acid[(benzofuran-2-yl)methylene]hydrazide

A mixture of 219.2 mg (1.5 mmol) benzo[b]furan-2-carboxaldehyde and 283.7 mg (2.25 mmol) furan-2-carboxylic acid hydrazide in 4 ml methanol was refluxed for 3 h. After cooling to room temperature a white solid precipitated, which was dried in vacuo. Yield: 398 mg of 95% purity according to ¹H NMR.

¹H NMR (d₆-DMSO; 400 MHz); 6.8 (s, 1H), 7.3 (m, 1H), 7.4 (m, 1H), 7.45 (m, 1H), 7.6 (d, 1H), 7.7 (d, 1H), 8.0 (s, 1H), 8.5 (s, 1H), 12.1 (s, 1H).

The compounds listed in the following tables 1 to 4 were prepared in an analogous way. Each of the compounds listed in table 4 show insecticidal activity against at least one of the mentioned insect species or against an aphid species when applied in low application rates, e.g. at an application rate of 500 ppm or lower.

TABLE I

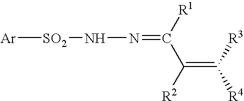

| Example | | | | | | m.p. or RT* |
|---|---|---|---|---|---|---|
| No.. | Ar | R¹ | R² | R³ | R⁴ | (HPLC/MS)) |
| 1. | thien-2-yl | H | CH₃ | H | phenyl | |
| 2. | 5-chlorothien-2-yl | H | Cl | H | phenyl | 178-180° C. |
| 3. | 5-chlorothien-2-yl | H | CH₃ | H | 4-fluorophenyl | 114-116° C. |
| 4. | 5-chlorothien-2-yl | H | CH₃ | H | 3-trifluoromethyl-phenyl | 117-119° C. |
| 5. | 5-chlorothien-2-yl | H | H | H | 4-methoxyphenyl | |
| 6. | 5-chlorothien-2-yl | H | H | H | phenyl | 145-147° C. |
| 7. | 5-chlorothien-2-yl | H | CH₃ | H | phenyl | 143-145° C. |
| 8. | 4,5-dichlorothien-2-yl | H | CH₃ | H | phenyl | |
| 9. | 2,5-dichlorothien-3-yl | H | H | H | phenyl | 142-144° C. |
| 10. | 2,5-dichlorothien-3-yl | H | CH₃ | H | phenyl | 129-131° C. |
| 11. | 4-bromo-2,5- | H | H | H | phenyl | 167-169° C. |
| | dichlorothien-3-yl | | | | | |

TABLE 2

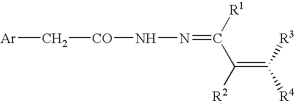

| Example | | | | | | |
|---|---|---|---|---|---|---|
| No. | Ar | R¹ | R² | R³ | R⁴ | m.p. or RT* (HPLC/MS)) |
| 12. | thien-2-yl | H | CH₃ | H | phenyl | |
| 13. | thien-3-yl | H | H | CH₃ | phenyl | 184° C. |
| 14. | thien-3-yl | H | H | Cl | phenyl | 152-153° C. |
| 15. | thien-3-yl | H | Cl | H | phenyl | 205-212° C. |
| 16. | thien-3-yl | H | H | H | 2-methoxyphenyl | 164-165° C. |
| 17. | phenyl | H | Cl | H | phenyl | 3.255 min |
| | | | | | | m/z = 299[M + H]⁺ |
| 18. | phenyl | H | CH₃ | H | phenyl | 3.239 min |
| | | | | | | m/z = 279[M + H]⁺ |
| 19. | phenyl | H | CH₃ | H | 3-fluorophenyl | 3.620 min |
| | | | | | | m/z = 297[M + H]⁺ |
| 20. | 3,4-dimethoxyphenyl | H | CH₃ | H | 4-fluorophenyl | 3.359 min |
| | | | | | | m/z = 357[M + H]⁺ |
| 21. | 1-naphthyl | H | CH₃ | H | 3-fluorophenyl | 4.001 min |
| | | | | | | m/z = 347[M + H]⁺ |
| 22. | indol-3-yl | H | CH₃ | H | 4-fluorophenyl | 3.454 min |
| | | | | | | m/z = 336[M + H]⁺ |
| 23. | indol-3-yl | H | CH₃ | H | 3-fluorophenyl | 3.464 min |
| | | | | | | m/z = 336 [M + H]⁺ |
| 24. | 4-fluorophenyl | H | CH₃ | H | phenyl | 3.521 min |
| | | | | | | m/z = 297 [M + H]⁺ |
| 25. | 4-fluorophenyl | H | CH₃ | H | 3-fluorophenyl | 3.569 min |
| | | | | | | m/z = 315 [M + H] |
| 26. | 3-methoxyphenyl | H | CH₃ | H | phenyl | 3.450 min |
| | | | | | | m/z = 309 [M + H]⁺ |
| 27. | 2-fluorophenyl | H | CH₃ | H | phenyl | 3.535 min |
| | | | | | | m/z = 297 [M + H]⁺ |
| 28. | 2-fluorophenyl | H | CH₃ | H | 4-fluorophenyl | 3.571 min |
| | | | | | | m/z = 315 [M + H]⁺ |
| 29. | 2-fluorophenyl | H | CH₃ | H | 3-fluorophenyl | 3.586 min |
| | | | | | | m/z = 315 [M + H]⁺ |
| 30. | 3-trifluoromethyl- | H | CH₃ | H | phenyl | 3.855 min |
| | phenyl | | | | | m/z = 347 [M + H]⁺ |
| 31. | 3-trifluoromethyl- | H | CH₃ | H | 2-fluorophenyl | 3.868 min |
| | phenyl | | | | | m/z = 365 [M + H]⁺ |
| 32. | 4-chlorophenyl | H | CH₃ | H | 4-fluorophenyl | 3.760 min |
| | | | | | | m/z = 331 [M + H]⁺ |
| 33. | 3-chlorophenyl | H | CH₃ | H | 4-fluorophenyl | 3.771 min |
| | | | | | | m/z = 331 [M + H]⁺ |
| 34. | 3-chlorophenyl | H | CH₃ | H | 3-fluorophenyl | 3.785 min |
| | | | | | | m/z = 331 [M + H]⁺ |
| 35. | 3-chlorophenyl | H | CH₃ | H | 2-fluorophenyl | 3.765 min |
| | | | | | | m/z = 331 [M + H]⁺ |
| 36. | 2-chloro-4- | H | CH₃ | H | 3-fluorophenyl | 3.823 min |
| | fluorophenyl | | | | | m/z = 349 [M + H]⁺ |

TABLE 3

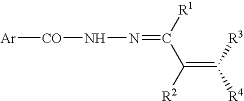

| Example | | | | | | |
|---|---|---|---|---|---|---|
| No. | Ar | R¹ | R² | R³ | R⁴ | m.p. or RT (HPLC/MS)) |
| 37. | thien-2-yl | H | (CH₂)₅CH₃ | H | phenyl | 126-128° C. |
| 38. | thien-2-yl | H | CH₃ | H | 4-fluorophenyl | 161-163° C. |
| 39. | thien-2-yl | H | CH₃ | H | 4-chlorophenyl | 138-140° C. |
| 40. | thien-2-yl | H | CH₃ | H | 2-chlorophenyl | 170-172° C. |
| 41. | thien-2-yl | H | CH₃ | H | 3-chloro-4-fluorophenyl | 173-175° C. |
| 42. | thien-2-yl | H | CH₃ | H | 3,4-difluorophenyl | 164-166° C. |
| 43. | thien-2-yl | H | phenyl | H | 4-fluorophenyl | 144-146° C. |
| 44. | thien-2-yl | H | CH(CH₃)₂ | H | 4-fluorophenyl | 175-177° C. |
| 45. | thien-2-yl | H | Cl | H | 4-fluorophenyl | 164-166° C. |
| 46. | thien-2-yl | H | H | H | 4-fluorophenyl | 146-148° C. |
| 47. | thien-2-yl | H | CH₃ | H | 3,4,5-trifluorophenyl | 202-204° C. |
| 48. | thien-2-yl | H | Cl | H | 3-fluoro-4-trifluoromethyl-phenyl | 178-180° C. |
| 49. | thien-2-yl | H | Br | H | phenyl | |
| 50. | thien-2-yl | H | CH₃ | H | phenyl | |
| 51. | thien-2-yl | H | Cl | H | phenyl | |
| 52. | thien-2-yl | H | H | H | 2-nitrophenyl | |
| 53. | thien-2-yl | H | H | H | phenyl | |
| 54. | thien-2-yl | CH₃ | H | H | phenyl | |
| 55. | thien-2-yl | H | CH₃ | H | 2-trifluoromethoxy-phenyl | 163-164° C. |
| 56. | thien-2-yl | H | CH₃ | H | 3-trifluoromethoxy-phenyl | 148-150° C. |
| 57. | thien-2-yl | H | H | H | 4-methoxyphenyl | 173-174°C. |
| 58. | thien-2-yl | H | CH₃ | H | 2,4-difluorophenyl | 185-187° C. |
| 59. | thien-2-yl | H | CH₃ | H | 3-(3-trifluoromethyl-phenoxy)phenyl | 116-118° C. |
| 60. | thien-2-yl | H | CH₃ | H | 4-trifluoromethyl-phenyl | 155-157° C. |
| 61. | thien-2-yl | H | CH₃ | H | 2-fluoro-4-trifluoromethyl-phenyl | 188-190° C. |
| 62. | thien-2-yl | H | CH₃ | H | 3-difluoromethoxy-phenyl | 118-120° C. |
| 63. | thien-2-yl | H | CH₃ | H | 4-trifluoromethoxy-phenyl | 150-152° C. |
| 64. | thien-2-yl | H | CH₃ | H | 2-difluoromethoxy-phenyl | |
| 65. | thien-2-yl | H | CH₃ | H | 3-trifluoromethyl-phenyl | 175-177° C. |
| 66. | thien-2-yl | H | F | H | phenyl | 218-222° C. |
| 67. | thien-2-yl | H | CH₃ | H | 3-fluorophenyl | 153-154° C. |
| 68. | thien-2-yl | H | H | Cl | phenyl | 100-102° C. |
| 69. | thien-2-yl | H | Cl | H | phenyl | 3.465 min |
| | | | | | | m/z = 291 [M + H]⁺ |
| 70. | thien-2-yl | H | CH₃ | H | 3-fluorophenyl | 3.565 min |
| | | | | | | m/z = 289 [M + H]⁺ |
| 71. | thien-2-yl | H | CH₃ | H | 4-fluorophenyl | 3.588 min |
| | | | | | | m/z = 289 [M + H]⁺ |
| 72. | 3-methyl-thien-2-yl | H | H | H | 4-fluorophenyl | 182-184° C. |
| 73. | 3-methyl-thien-2-yl | H | CH₃ | H | phenyl | 175-177° C. |
| 74. | 3-methyl-thien-2-yl | H | H | H | phenyl | 178-180° C. |
| 75. | 3-methyl-thien-2-yl | H | CH₃ | H | 4-difluoromethoxy-phenyl | 160-162° C. |
| 76. | 3-methyl-thien-2-yl | H | CH₃ | H | phenyl | 3.589 min |
| | | | | | | m/z = 285 [M + H]⁺ |
| 77. | 5-methyl-thien-2-yl | H | CH₃ | H | 4-fluorophenyl | 156-158° C. |
| 78. | 5-methyl-thien-2-yl | H | CH₃ | H | 4-chlorophenyl | 191-193° C. |
| 79. | 5-methyl-thien-2-yl | H | CH₃ | H | 4-chloro-3-fluorophenyl | 173-175° C. |
| 80. | 5-methyl-thien-2-yl | H | CH₃ | H | 3-chloro-4-fluorophenyl | 107-109° C. |
| 81. | 5-methyl-thien-2-yl | H | CH(CH₃)₂ | H | 4-fluorophenyl | 172-174° C. |
| 82. | 5-methyl-thien-2-yl | H | Cl | H | 4-fluorophenyl | 170-172° C. |
| 83. | 5-methyl-thien-2-yl | H | H | H | 4-fluorophenyl | 174-176° C. |
| 84. | 5-methyl-thien-2-yl | H | CH₃ | H | 3-trifluoromethyl-phenyl | 173-175° C. |
| 85. | 5-methyl-thien-2-yl | H | CH₃ | H | 2,4-difluorophenyl | 110-112° C. |
| 86. | 5-methyl-thien-2-yl | H | CH₃ | H | 4-chloro-2-fluorophenyl | 154-156° C. |
| 87. | 5-methyl-thien-2-yl | H | CH₃ | H | 3-(3-trifluoromethyl-phenoxy)phenyl | 172-180° C. |
| 88. | 5-methyl-thien-2-yl | H | CH₃ | H | 4-trifluoromethyl-phenyl | 159-161° C. |
| 89. | 5-methyl-thien-2-yl | H | H | H | phenyl | 175-176° C. |
| 90. | 5-methyl-thien-2-yl | H | CH₃ | H | 3-difluoromethoxy-phenyl | 88-90° C. |
| 91. | 5-methyl-thien-2-yl | H | CH₃ | H | 4-difluoromethoxy-phenyl | |
| 92. | 5-methyl-thien-2-yl | H | Cl | H | phenyl | 172-176° C. |
| 93. | 5-methyl-thien-2-yl | H | CH₃ | H | 3-fluorophenyl | 198-201° C. |
| 94. | 5-chlorothien-2-yl | H | CH₃ | H | 3,4-dichlorophenyl | 187-189° C. |
| 95. | 5-chlorothien-2-yl | H | CH₃ | H | phenyl | |
| 96. | 5-chlorothien-2-yl | H | H | H | phenyl | 3.786 min |
| | | | | | | m/z = 291 [M + H]⁺ |
| 97. | 5-chlorothien-2-yl | H | Cl | H | phenyl | 4.055 min, |
| | | | | | | m/z = 325 [M + H]⁺ |
| 98. | 5-chlorothien-2-yl | H | CH₃ | H | 3-fluorophenyl | 185-187° C. |
| 99. | 5-chlorothien-2-yl | H | H | Cl | phenyl | 191-193° C. |
| 100. | 3-chloro-4-methyl-thien-2-yl | H | H | H | 4-hydroxy-3-methoxyphenyl | 214-216° C. |
| 101. | 3-chloro-4-methyl-thien-2-yl | H | H | H | phenyl | 176-180° C. |
| 102. | 3-chloro-4-methyl-thien-2-yl | H | Cl | H | phenyl | 194° C. |
| 103. | 3-chloro-4-methyl-thien-2-yl | H | CH₃ | H | phenyl | 161-162° C. |
| 104. | 3-chloro-4-methyl-thien-2-yl | H | H | Cl | phenyl | 151-153° C. |
| 105. | 3-chloro-4-methyl-thien-2-yl | H | CH₃ | H | 3-fluorophenyl | 173-174° C. |
| 106. | benzothien-2-yl | H | CH₃ | H | phenyl | 194-195° C. |
| 107. | benzothien-2-yl | H | H | H | phenyl | 219-220° C. |
| 108. | benzothien-2-yl | H | (CH₂)₂CH₃ | H | 2,4-dichlorophenyl | |
| 109. | benzothien-2-yl | H | CH₃ | H | 3-fluorophenyl | 3.964 min |
| | | | | | | m/z = 339 [M + H]⁺ |
| 110. | 3-chlorobenzothien-2-yl | H | H | H | phenyl | 204-206° C. |
| 111. | 3-ethoxythien-2-yl | H | CH₃ | H | phenyl | 138-140° C. |
| 112. | 3-ethoxythien-2-yl | H | H | H | phenyl | 99-102° C. |
| 113. | thien-3-yl | H | CH₃ | H | 3-trifluoromethoxyphenyl | |
| 114. | thien-3-yl | H | CH₃ | H | 4-difluoromethoxy-phenyl | 145-147° C. |
| 115. | thien-3-yl | H | CH₃ | H | phenyl | 142-144° C. |
| 116. | thien-3-yl | H | H | H | phenyl | 222-225° C. |
| 117. | thien-3-yl | H | H | H | 4-fluorophenyl | 205-208° C. |
| 118. | thien-3-yl | H | CH₃ | H | 4-trifluoromethoxy-phenyl | |
| 119. | thien-3-yl | H | CH₃ | H | 3-trifluoromethyl-phenyl | 168-170° C. |
| 120. | fur-2-yl | H | Cl | H | phenyl | 2.598 min |
| | | | | | | m/z = 275 [M + H]⁺ |
| 121. | fur-2-yl | H | CH₃ | H | phenyl | 2.528 min |
| | | | | | | m/z = 255 [M + H]⁺ |
| 122. | fur-2-yl | H | Br | H | phenyl | 2.819 min |
| | | | | | | m/z = 319 [M + H]⁺ |
| 123. | fur-2-yl | H | CH₃ | H | 4-methyl-phenyl | 3.035 min |
| | | | | | | m/z = 269 [M + H]⁺ |
| 124. | fur-2-yl | H | H | H | 3,5-dichlorophenyl | 3.167 min |
| | | | | | | m/z = 309 [M + H]⁺ |
| 125. | fur-2-yl | H | CH₃ | H | 2-methyl-phenyl | 2.900 min |
| | | | | | | m/z = 269 [M + H]⁺ |
| 126. | fur-2-yl | H | CH₂CH₃ | H | phenyl | 3.042 min |
| | | | | | | m/z = 269 [M + H]⁺ |
| 127. | fur-2-yl | H | CH₃ | H | 4-methoxyphenyl | 2.793 min |
| | | | | | | m/z = 285 [M + H]⁺ |
| 128. | fur-2-yl | H | CH₃ | H | 4-chlorophenyl | 3.102 min, |
| | | | | | | m/z = 289 [M + H]⁺ |
| 129. | fur-2-yl | H | H | H | 3-fluorophenyl | 2.640 min |
| | | | | | | m/z = 259 [M + H]⁺ |
| 130. | fur-2-yl | H | H | H | 2-fluorophenyl | 2.641 min |
| | | | | | | m/z = 259 [M + H]⁺ |
| 131. | fur-2-yl | H | CH₃ | H | 3-fluorophenyl | 3.121 min |
| | | | | | | m/z = 273 [M + H]⁺ |
| 132. | 5-bromofur-2-yl | H | CH₃ | H | phenyl | 156-157° C. |
| 133. | 5-methyl-isoxazol-3-yl | H | CH₃ | H | phenyl | 195° C. |
| 134. | 5-methyl-isoxazol-3-yl | H | H | H | phenyl | 207-208° C. |
| 135. | isoxazol-5-yl | H | CH₃ | H | phenyl | 188-190° C. |
| 136. | isoxazol-5-yl | H | CH₃ | H | 4-fluorophenyl | |
| 137. | 4-methyl-imidazol-5-yl | H | Br | H | phenyl | 2.197 min |
| | | | | | | m/z = 333 [M + H]⁺ |
| 138. | 4-methyl-imidazol-5-yl | H | CH₃ | H | 2,4-dichlorophenyl | 2.593 min |
| | | | | | | m/z = 337 [M + H]⁺ |
| 139. | 4-methyl-imidazol-5-yl | H | H | H | 3,5-dichlorophenyl | 2.520 min |
| | | | | | | m/z = 323 [M + H]⁺ |
| 140. | 4-methyl-imidazol-5-yl | H | CH₃ | H | 2-methyl-phenyl | 2.310 min |
| | | | | | | m/z = 283 [M + H]⁺ |
| 141. | 4-methyl-imidazol-5-yl | H | H | H | 3-fluoro-phenyl | 2.171 min |
| | | | | | | m/z = 273 [M + H]⁺ |
| 142. | 4-methyl-imidazol-5-yl | H | CH₃ | H | phenyl | 2.293 min |
| | | | | | | m/z = 269 [M + H]⁺ |
| 143. | 4-methyl-imidazol-5-yl | H | CH₃ | H | 4-fluorophenyl | 2.372 min |
| | | | | | | m/z = 287 [M + H]⁺ |
| 144. | 4-methyl-imidazol-5-yl | H | CH₃ | H | 3-fluorophenyl | |
| 145. | 1,5-dimethyl-pyrazol-3-yl | H | H | H | phenyl | |
| 146. | 1,5-dimethyl-pyrazol-3-yl | H | CH₃ | H | phenyl | 144-146° C. |
| 147. | 1,5-dimethyl-pyrazol-3-yl | H | Cl | H | phenyl | 159-161° C. |
| 148. | 3-methyl-pyrazol-5-yl | H | CH₃ | H | phenyl | |
| 149. | 1-(4-chlorophenyl)-5-trifluoromethyl-pyrazol-4- | H | Cl | H | phenyl | 104° C. |
| | yl | | | | | |
| 150. | 1-(4-chlorophenyl)-5-trifluoromethyl-pyrazol-4- | H | CH₃ | H | phenyl | 165° C. |
| | yl | | | | | |
| 151. | 1-(4-chlorophenyl)-5-trifluoromethyl-pyrazol-4- | H | H | H | phenyl | 134° C. |
| | yl | | | | | |
| 152. | 1,3-dimethyl-pyrazol-5-yl | H | CH₃ | H | phenyl | |
| 153. | 4-chloro-1,3-dimethyl-pyrazol-5-yl | H | H | H | phenyl | 185-187° C. |
| 154. | 2-methyl-4-trifluoromethyl-thiazol-5-yl | H | CH₃ | H | phenyl | 178-179° C. |
| 155. | indol-2-yl | H | CH₃ | H | phenyl | |
| 156. | pyrid-2-yl | H | CH₃ | H | phenyl | 3.059 min |
| | | | | | | m/z = 266 [M + H]⁺ |
| 157. | pyrid-2-yl | H | Cl | H | phenyl | 3.094 min |
| | | | | | | m/z = 286 [M + H]⁺ |
| 158. | pyrid-2-yl | H | CH₃ | H | 4-fluorophenyl | 3.161 min |
| | | | | | | m/z = 284 [M + H]⁺ |
| 159. | pyrid-2-yl | H | CH₃ | H | 3-fluorophenyl | 3.178 min |
| | | | | | | m/z = 284 [M + H]⁺ |
| 160. | pyrid-3-yl | H | CH₃ | H | phenyl | |
| 161. | pyrid-3-yl | H | CH₃ | H | 3-trifluoromethyl-phenyl | |
| 162. | pyrid-3-yl | H | Cl | H | phenyl | |
| 163. | pyrid-3-yl | H | CH₃ | H | 4-fluorophenyl | |
| 164. | pyrid-3-yl | H | CH₃ | H | 3-fluorophenyl | 194-197° C. |
| 165. | 6-chloropyrid-3-yl | H | CH₃ | H | phenyl | 189-191° C. |
| 166. | 6-chloropyrid-3-yl | H | Cl | H | phenyl | 205-206° C. |
| 167. | 6-bromopyrid-3-yl | H | H | H | phenyl | 221-222° C. |
| 168. | 4-trifluoromethyl-pyrid-3-yl | H | CH₃ | H | phenyl | |
| 169. | 4-trifluoromethyl-pyrid-3-yl | H | CH₃ | H | 4-fluorophenyl | |
| 170. | pyrid-4-yl | H | Cl | H | phenyl | 2.319 min |
| | | | | | | m/z = 286 [M + H]⁺ |
| 171. | pyrid-4-yl | H | CH₃ | H | phenyl | 2.198 min |
| | | | | | | m/z = 266 [M + H]⁺ |
| 172. | pyrid-4-yl | H | CH₃ | H | 4-fluorophenyl | 2.419 min |
| | | | | | | m/z = 284 [M + H]⁺ |
| 173. | pyrid-4-yl | H | CH₃ | H | 3-fluorophenyl | 2.424 min |
| | | | | | | m/z = 284 [M + H]⁺ |
| 174. | 2-chloropyrid-4-yl | H | CH₃ | H | phenyl | 188° C. |
| 175. | 2-chloropyrid-4-yl | H | H | H | phenyl | 194-195° C. |
| 176. | 2-chloropyrid-4-yl | H | Cl | H | phenyl | 200° C. |
| 177. | pyrazin-2-yl | H | CH₃ | H | phenyl | |
| 178. | pyrazin-2-yl | H | CH₃ | H | 4-fluorophenyl | |
| 179. | pyrazin-2-yl | H | CH₃ | H | 3-ethoxyphenyl | |
| 180. | phenyl | H | CH₃ | H | phenyl | 3.122 min |
| | | | | | | m/z = 265 [M + H]⁺ |
| 181. | phenyl | H | CH₃ | H | 4-fluorophenyl | 3.245 min |
| | | | | | | m/z = 283 [M + H]⁺ |
| 182. | 3-methyl-phenyl | H | CH₃ | H | 3-fluorophenyl | 3.476 min |
| | | | | | | m/z = 297 [M + H]⁺ |
| 183. | 4-methyl-phenyl | H | CH₃ | H | phenyl | 3.080 min |
| | | | | | | m/z = 279 [M + H]⁺ |
| 184. | 4-hydroxyphenyl | H | CH₃ | H | 4-fluorophenyl | 2.900 min |
| | | | | | | m/z = 299 [M + H]⁺ |
| 185. | 3,4-dimethoxyphenyl | H | CH₃ | H | phenyl | 2.831 min |
| | | | | | | m/z = 325 [M + H]⁺ |
| 186. | 2-methoxyphenyl | H | CH₃ | H | 4-fluorophenyl | 3.410 min |
| | | | | | | m/z = 313 [M + H]⁺ |
| 187. | 2-methoxyphenyl | H | CH₃ | H | 3-fluorophenyl | 3.427 min |
| | | | | | | m/z = 313 [M + H]⁺ |
| 188. | 4-methoxyphenyl | H | CH₃ | H | phenyl | 2.945 min |
| | | | | | | m/z = 295 [M + H]⁺ |
| 189. | 4-fluorophenyl | H | CH₂CH₃ | H | phenyl | 3.565 min |
| | | | | | | m/z = 297 [M + H]⁺ |
| 190. | 4-fluorophenyl | H | CH₃ | H | phenyl | 3.300 min |
| | | | | | | m/z = 283 [M + H]⁺ |
| 191. | 4-fluorophenyl | H | CH₃ | H | 4-fluorophenyl | 3.347 min |
| | | | | | | m/z = 301 [M + H]⁺ |
| 192. | 2-fluorophenyl | H | Br | H | phenyl | 3.365 min |
| | | | | | | m/z = 348 [M + H]⁺ |
| 193. | 2-fluorophenyl | H | CH₂CH₃ | H | phenyl | 3.611 min |
| | | | | | | m/z = 297 [M + H]⁺ |
| 194. | 2-fluorophenyl | H | CH₃ | H | phenyl | 3.345 min |
| | | | | | | m/z = 283 [M + H]⁺ |
| 195. | 2-fluorophenyl | H | Cl | H | phenyl | 3.384 min |
| | | | | | | m/z = 303 [M + H]⁺ |
| 196. | 2-fluorophenyl | H | H | H | phenyl | 3.046 min |
| | | | | | | m/z = 269 [M + H]⁺ |
| 197. | 2-fluorophenyl | H | H | H | 2-fluorophenyl | 3.192 min |
| | | | | | | m/z = 287 [M + H]⁺ |
| 198. | 2-fluorophenyl | H | CH₃ | H | 3-fluorophenyl | 3.383 min |
| | | | | | | m/z = 301 [M + H]⁺ |
| 199. | 2-fluorophenyl | H | CH₃ | H | 4-fluorophenyl | 3.366 min |
| | | | | | | m/z = 301 [M + H]⁺ |
| 200. | 3-fluorophenyl | H | CH₂CH₃ | H | phenyl | 3.620 min |
| | | | | | | m/z = 297 [M + H]⁺ |
| 201. | 3-fluorophenyl | H | CH₃ | H | 3-fluorophenyl | 3.401 min |
| | | | | | | m/z = 301 [M + H]⁺ |
| 202. | 2,5-difluorophenyl | H | CH₃ | H | 4-fluorophenyl | 3.479 min |
| | | | | | | m/z = 319 [M + H]⁺ |
| 203. | 2,5-difluorophenyl | H | CH₃ | H | 3-fluorophenyl | 3.494 min |
| | | | | | | m/z = 319 [M + H]⁺ |
| 204. | 2,5-difluorophenyl | H | CH₃ | H | 2-methyl-phenyl | 3.584 min |
| | | | | | | m/z = 315 [M + H]⁺ |
| 205. | 2,5-difluorophenyl | H | CH₃ | H | 4-methoxyphenyl | 3.425 min |
| | | | | | | m/z = 331 [M + H]⁺ |
| 206. | 2,6-difluorophenyl | H | CH₃ | H | 4-fluorophenyl | 3.539 min |
| | | | | | | m/z = 319 [M + H]⁺ |
| 207. | 2,6-difluorophenyl | H | CH₃ | H | 3-fluorophenyl | 3.485 min |
| | | | | | | m/z = 319 [M + H]⁺ |
| 208. | 3,4-difluorophenyl | H | CH₃ | H | 4-fluorophenyl | 3.460 min |
| | | | | | | m/z = 319 [M + H]⁺ |
| 209. | 3,5-dichlorophenyl | H | CH₃ | H | 3-fluorophenyl | 3.963 min |
| | | | | | | m/z = 351 [M + H]⁺ |
| 210. | 2-naphthyl | H | CH₃ | H | 3-fluorophenyl | 3.699 min |
| | | | | | | m/z = 333 [M + H]⁺ |
| 211. | thien-2-yl | H | CH₃ | H | 2-fluorophenyl | 180-182° C. |
| 212. | thien-2-yl | H | CH₃ | H | 3-chlorophenyl | 155-158° C. |
| 213. | thien-2-yl | H | CH₃ | H | 3-methylphenyl | 163-165° C. |
| 214. | 3-methoxythien-2-yl | H | CH₃ | H | 2,5-difluorophenyl | 3.310 min |
| | | | | | | m/z = 337 [M + H]⁺ |
| 215. | 3-methoxythien-2-yl | H | CH₃ | H | 2,3-difluorophenyl | 3.338 min |
| | | | | | | m/z = 337 [M + H]⁺ |
| 216. | 3-methoxythien-2-yl | H | CH₃ | H | 3,5-difluorophenyl | 3.372 min |
| | | | | | | m/z = 337 [M + H]⁺ |
| 217. | 3-methoxythien-2-yl | H | CH₃ | H | 3,4-difluorophenyl | 3.299 min |
| | | | | | | m/z = 337 [M + H]⁺ |
| 218. | 3-methyl-thien-2-yl | H | CH₃ | H | 3,5-difluorophenyl | 3.607 min |
| | | | | | | m/z = 321 min [M + H]⁺ |
| 219. | 5-nitrothien-2-yl | H | CH₃ | H | 3,5-difluorophenyl | 3.463 min |
| | | | | | | m/z = 352 [M + H]⁺ |
| 220. | 2-bromo-4,5-dimethyl-thien-3-yl | H | CH₃ | H | 3,5-difluorophenyl | 3.847 min |
| | | | | | | m/z = 415 [M + H]⁺ |
| 221. | fur-2-yl | H | CH₃ | H | 3,4-difluorophenyl | 3.003 min |
| | | | | | | m/z = 291 [M + H]⁺ |
| 222. | fur-2-yl | H | CH₃ | H | 2,5-difluorophenyl | 3.002 min |
| | | | | | | m/z = 291 [M + H]⁺ |
| 223. | fur-2-yl | H | CH₃ | H | 2,3-difluorophenyl | 3.034 min |
| | | | | | | m/z = 291 [M + H]⁺ |
| 224. | fur-2-yl | H | CH₃ | H | 3,5-difluorophenyl | 3.085 min |
| | | | | | | m/z = 291 [M + H]⁺ |
| 225. | 5-bromofur-2-yl | H | CH₃ | H | 4-fluorophenyl | 3.366 min |
| | | | | | | m/z = 353 [M + H]⁺ |
| 226. | 5-bromofur-2-yl | H | CH₃ | H | 3-fluorophenyl | 3.371 min |
| | | | | | | m/z = 351 [M + H]⁺ |
| 227. | 2-methyl-fur-3-yl | H | CH₃ | H | 3,5-difluorophenyl | 3.320 min |
| | | | | | | m/z = 305 [M + H]⁺ |
| 228. | 5-methyl-isoxazol-3-yl | H | CH₃ | H | 4-fluorophenyl | 3.101 min |
| | | | | | | m/z = 288 [M + H]⁺ |
| 229. | 5-methyl-isoxazol-3-yl | H | CH₃ | H | 3-fluorophenyl | 3.112 min |
| | | | | | | m/z = 288 [M + H]⁺ |
| 230. | 5-chloromethyl-isoxazol-3-yl | H | CH₃ | H | phenyl | 3.240 min |
| | | | | | | m/z = 304 [M + H]⁺ |
| 231. | 5-chloromethyl-isoxazol-3-yl | H | CH₃ | H | 4-fluorophenyl | 3.371 min |
| | | | | | | m/z = 322 [M + H]⁺ |
| 232. | 5-chloromethyl-isoxazol-3-yl | H | CH₃ | H | 3-fluorophenyl | 3.297 min |
| | | | | | | m/z = 322 [M + H]⁺ |
| 233. | 3-ethyl-isoxazol-5-yl | H | CH₃ | H | phenyl | 3.100 min |
| | | | | | | m/z = 284 [M + H]⁺ |
| 234. | 3-ethyl-isoxazol-5-yl | H | CH₃ | H | 4-fluorophenyl | 3.160 min |
| | | | | | | m/z = 302 [M + H]⁺ |
| 235. | 5-iso-propyl-isoxazol-3-yl | H | CH₃ | H | phenyl | 3.504 min |
| | | | | | | m/z = 298 [M + H]⁺ |
| 236. | 5-iso-propyl-isoxazol-3-yl | H | CH₃ | H | 4-fluorophenyl | 3.541 min |
| | | | | | | m/z = 316 [M + H]⁺ |
| 237. | 5-iso-propyl-isoxazol-3-yl | H | CH₃ | H | 3-fluorophenyl | 3.553 min |
| | | | | | | m/z = 316 [M + H]⁺ |
| 238. | 3-iso-propyl-isoxazol-5-yl | H | CH₃ | H | phenyl | 3.365 min |
| | | | | | | m/z = 298 [M + H]⁺ |
| 239. | 3-iso-propyl-isoxazol-5-yl | H | CH₃ | H | 4-fluorophenyl | 3.343 min |
| | | | | | | m/z = 316 [M + H]⁺ |
| 240. | 3-iso-propyl-isoxazol-5-yl | H | CH₃ | H | 3-fluorophenyl | 3.408 min |
| | | | | | | m/z = 316 [M + H]⁺ |
| 241. | 3-iso-propyl-isoxazol-5-yl | H | CH₃ | H | 2-fluorophenyl | 3.393 min |
| | | | | | | m/z = 316 [M + H]⁺ |
| 242. | pyrid-2-yl | H | CH₃ | H | 2,5-difluorophenyl | 3.161 min |
| | | | | | | m/z = 302 [M + H]⁺ |
| 243. | pyrid-2-yl | H | CH₃ | H | 2,3-difluorophenyl | 3.190 min |
| | | | | | | m/z = 302 [M + H]⁺ |
| 244. | pyrid-2-yl | H | CH₃ | H | 3,5-difluorophenyl | 3.229 min |
| | | | | | | m/z = 302 [M + H]⁺ |
| 245. | pyrid-2-yl | H | CH₃ | H | 4-methyl-phenyl | 3.224 min |
| | | | | | | m/z = 280 [M + H]⁺ |
| 246. | pyrid-2-yl | H | CH₂CH₃ | H | phenyl | 3.235 min |
| | | | | | | m/z = 280 [M + H]⁺ |
| 247. | pyrid-2-yl | H | CH₃ | H | 4-chlorophenyl | 3.264 min |
| | | | | | | m/z = 300 [M + H]⁺ |
| 248. | pyrid-2-yl | H | H | H | 2-methyl-phenyl | 2.826 min |
| | | | | | | m/z = 266 [M + H]⁺ |
| 249. | pyrid-2-yl | H | H | H | 3-fluorophenyl | 2.781 min |
| | | | | | | m/z = 270 [M + H]⁺ |
| 250. | pyrid-2-yl | H | H | H | 2-fluorophenyl | 2.744 min |
| | | | | | | m/z = 270 [M + H]⁺ |
| 251. | pyrid-2-yl | H | H | H | 2-methoxyphenyl | 2.752 min |
| | | | | | | m/z = 282 [M + H]⁺ |
| 252. | pyrid-2-yl | H | H | H | 2-bromophenyl | 3.088 min |
| | | | | | | m/z = 330 [M + H]⁺ |
| 253. | pyrid-2-yl | H | CH₃ | H | 3-methyl-phenyl | 3.256 min |
| | | | | | | m/z = 280 [M + H]⁺ |
| 254. | pyrid-2-yl | H | CH₃ | H | 2-methoxyphenyl | 2.984 min |
| | | | | | | m/z = 296 [M + H]⁺ |
| 255. | pyrid-2-yl | H | H | H | 2-bromophenyl | 3.088 min |
| | | | | | | m/z = 330 [M + H]⁺ |
| 256. | pyrid-2-yl | H | CH₃ | H | 3-methyl-phenyl | 3.256 min |
| | | | | | | m/z = 280 [M + H]⁺ |
| 257. | pyrid-2-yl | H | CH₃ | H | 2-methoxyphenyl | 2.984 min |
| | | | | | | m/z = 296 [M + H]⁺ |
| 258. | pyrid-2-yl | H | Br | H | phenyl | 2.998 min |
| | | | | | | m/z = 332 [M + H]⁺ |
| 259. | pyrid-2-yl | H | H | H | 2-chlorophenyl | 3.027 min |
| | | | | | | m/z = 286 [M + H]⁺ |
| 260. | pyrid-2-yl | H | CH₃ | H | 2-fluorophenyl | 3.034 min |
| | | | | | | m/z = 284 [M + H]⁺ |
| 261. | pyrid-2-yl | H | CH₃ | H | 2-chlorophenyl | 3.231 min |
| | | | | | | m/z = 300 [M + H]⁺ |
| 262. | 3-methyl-pyrid-2-yl | H | CH₃ | H | 3-fluorophenyl | 3.048 min |
| | | | | | | m/z = 298 [M + H]⁺ |
| 263. | 3-methyl-pyrid-2-yl | H | CH₃ | H | 2,5-difluorophenyl | 3.105 min |
| | | | | | | m/z = 316 [M + H]⁺ |
| 264. | 3-methyl-pyrid-2-yl | H | CH₃ | H | 2,3-difluorophenyl | 3.134 min |
| | | | | | | m/z = 316 [M + H]⁺ |
| 265. | 3-methyl-pyrid-2-yl | H | CH₃ | H | 3,5-difluorophenyl | 3.177 min |
| | | | | | | m/z = 316 [M + H]⁺ |
| 266. | 6-methyl-pyrid-2-yl | H | CH₃ | H | 2,5-difluorophenyl | 3.282 min |
| | | | | | | m/z = 316 [M + H]⁺ |
| 267. | 6-methyl-pyrid-2-yl | H | CH₃ | H | 2,3-difluorophenyl | 3.259 min |
| | | | | | | m/z = 316 [M + H]⁺ |
| 268. | 6-methyl-pyrid-2-yl | H | CH₃ | H | 3,5-difluorophenyl | 3.299 min |
| | | | | | | m/z = 316 [M + H]⁺ |
| 269. | 6-methyl-pyrid-2-yl | H | CH₃ | H | 3,4-difluorophenyl | 3.260 min |
| | | | | | | m/z = 316 [M + H]⁺ |
| 270. | 6-methyl-pyrid-2-yl | H | CH₃ | H | 4-fluorophenyl | 3.352 min |
| | | | | | | m/z = 298 [M + H]⁺ |
| 271. | 6-bromopyrid-2-yl | H | CH₃ | H | 3-fluorophenyl | 3.507 min |
| | | | | | | m/z = 362 [M + H]⁺ |
| 272. | 6-bromopyrid-2-yl | H | CH₃ | H | 2,5-difluorophenyl | 3.537 min |
| | | | | | | m/z = 382 [M + H]⁺ |
| 273. | 6-bromopyrid-2-yl | H | CH₃ | H | 2,3-difluorophenyl | 3.565 min |
| | | | | | | m/z = 382 [M + H]⁺ |
| 274. | 6-bromopyrid-2-yl | H | CH₃ | H | 4-fluorophenyl | 3.649 min |
| | | | | | | m/z = 362 [M + H]⁺ |
| 275. | 4-chloropyrid-2-yl | H | CH₃ | H | phenyl | 3.433 min |
| | | | | | | m/z = 300 [M + H]⁺ |
| 276. | 4-chloropyrid-2-yl | H | CH₃ | H | 4-fluorophenyl | 3.470 min |
| | | | | | | m/z = 318 [M + H]⁺ |
| 277. | 4-chloropyrid-2-yl | H | CH₃ | H | 3-fluorophenyl | 3.480 min |
| | | | | | | m/z = 318 [M + H]⁺ |
| 278. | 4-chloropyrid-2-yl | H | CH₃ | H | 2-fluorophenyl | 3.472 min |
| | | | | | | m/z = 318 [M + H]⁺ |
| 279. | 6-phenyl-pyrid-2-yl | H | CH₃ | H | phenyl | 3.957 min |
| | | | | | | m/z = 342 [M + H]⁺ |
| 280. | 6-phenyl-pyrid-2-yl | H | CH₃ | H | 4-fluorophenyl | 3.978 min |
| | | | | | | m/z = 360 [M + H]⁺ |
| 281. | 6-phenyl-pyrid-2-yl | H | CH₃ | H | 3-fluorophenyl | 3.957 min |
| | | | | | | m/z = 360 [M + H]⁺ |
| 282. | 6-phenyl-pyrid-2-yl | H | CH₃ | H | 2-fluorophenyl | 3.958 min |
| | | | | | | m/z = 360 [M + H]⁺ |
| 283. | 5-trifluoromethyl-pyrid-2-yl | H | CH₃ | H | phenyl | 3.584 min |
| | | | | | | m/z = 334 [M + H]⁺ |
| 284. | 5-trifluoromethyl-pyrid-2-yl | H | CH₃ | H | 4-fluorophenyl | 3.629 min |
| | | | | | | m/z = 352 [M + H]⁺ |
| 285. | 5-trifluoromethyl-pyrid-2-yl | H | CH₃ | H | 3-fluorophenyl | 3.578 min |
| | | | | | | m/z = 352 [M + H]⁺ |
| 286. | 6-trifluoromethyl-pyrid-2-yl | H | CH₃ | H | phenyl | 3.652 min |
| | | | | | | m/z = 334 [M + H]⁺ |
| 287. | 6-trifluoromethyl-pyrid-2-yl | H | CH₃ | H | 4-fluorophenyl | 3.683 min |
| | | | | | | m/z = 352 [M + H]⁺ |
| 288. | 6-trifluoromethyl-pyrid-2-yl | H | CH₃ | H | 2-fluorophenyl | 3.678 min |
| | | | | | | m/z = 352 [M + H]⁺ |
| 289. | 3,6-dichloropyrid-2-yl | H | CH₃ | H | phenyl | 3.468 min |
| | | | | | | m/z = 334 [M + H]⁺ |
| 290. | 3,6-dichloropyrid-2-yl | H | CH₃ | H | 4-fluorophenyl | 3.498 min |
| | | | | | | m/z = 352 [M + H]⁺ |
| 291. | 3,6-dichloropyrid-2-yl | H | CH₃ | H | 3-fluorophenyl | 3.513 min |
| | | | | | | m/z = 352 [M + H]⁺ |
| 292. | 5-bromopyrid-3-yl | H | CH₃ | H | 2,3-difluorophenyl | 3.238 min |
| | | | | | | m/z = 380 [M + H]⁺ |
| 293. | 4-trifluoromethyl-pyrid-3-yl | H | CH₃ | H | 3-fluorophenyl | 3.188 min |
| | | | | | | m/z = 352 [M + H]⁺ |
| 294. | 4-trifluoromethyl-pyrid-3-yl | H | CH₃ | H | 3,4-difluorophenyl | 3.268 min |
| | | | | | | m/z = 370 [M + H]⁺ |
| 295. | 4-trifluoromethyl-pyrid-3-yl | H | CH₃ | H | 2,5-difluorophenyl | 3.215 min |
| | | | | | | m/z = 370 [M + H]⁺ |
| 296. | 4-trifluoromethyl-pyrid-3-yl | H | CH₃ | H | 2,3-difluorophenyl | 3.234 min |
| | | | | | | m/z = 370 [M + H]⁺ |
| 297. | 4-trifluoromethyl-pyrid-3-yl | H | CH₃ | H | 3,5-difluorophenyl | 3.297 min |
| | | | | | | m/z = 370 [M + H]⁺ |
| 298. | pyrid-3-yl | H | CH₃ | H | 2-chlorophenyl | 146-148° C. |
| 299. | pyrid-3-yl | H | CH₃ | H | 2-fluorophenyl | 137-140° C. |
| 300. | pyrid-3-yl | H | CH₃ | H | 3-chlorophenyl | 164-166° C. |
| 301. | pyrid-3-yl | H | CH₃ | H | 3-methoxyphenyl | |
| 302. | pyrid-3-yl | H | CH₃ | H | 3-methylphenyl | |
| 303. | pyrid-3-yl | H | CH₃ | H | 4-fluorophenyl | 185-188° C. |
| 304. | pyrid-3-yl | H | CH₃ | H | 3,5-difluorophenyl | 2.493 min |
| | | | | | | m/z = 302 [M + H]⁺ |
| 305. | pyrid-4-yl | H | 4-fluoro- | H | 4-chlorophenyl | 213-215° C. |
| | | | phenyl | | | |
| 306. | pyrid-4-yl | H | Phenyl | H | 2,6-dichlorophenyl | 214-218° C. |
| 307. | pyrid-4-yl | H | Phenyl | H | 2-chlorophenyl | 201-203° C. |
| 308. | pyrid-4-yl | H | CH₃ | H | 3,5-difluorophenyl | 2.492 min |
| | | | | | | m/z = 302 [M + H]⁺ |
| 309. | 2-chloropyrid-4-yl | H | CH₃ | H | 3-fluorophenyl | 3.136 min |
| | | | | | | m/z = 318 [M + H]⁺ |
| 310. | 2-chloropyrid-4-yl | H | CH₃ | H | 3,4-difluorophenyl | 3.211 min |
| | | | | | | m/z = 336 [M + H]⁺ |
| 311. | 6-hydroxy-2-methyl-pyrimid-4-yl | H | CH₃ | H | 4-fluorophenyl | 2.644 min |
| | | | | | | m/z = 315 [M + H]⁺ |
| 312. | 5-bromo-2-methyl-thio-pyrimid-4-yl | H | CH₃ | H | 2-fluorophenyl | 3.614 min |
| | | | | | | m/z = 411 [M + H]⁺ |
| 313. | pyrazinyl | H | CH₃ | H | 3-fluorophenyl | 2.783 min |
| | | | | | | m/z = 285 [M + H]⁺ |
| 314. | pyrazinyl | H | CH₃ | H | 2-fluorophenyl | 2.809 min |
| | | | | | | m/z = 285 [M + H]⁺ |
| 315. | phenyl | H | CH₂CH₃ | H | phenyl | 3.149 min |
| | | | | | | m/z = 279 [M + H]⁺ |
| 316. | phenyl | H | H | H | 3-fluorophenyl | 2.761 min |
| | | | | | | m/z = 269 [M + H]⁺ |
| 317. | phenyl | H | H | H | 2-fluorophenyl | 2.765 min |
| | | | | | | m/z = 269 [M + H]⁺ |
| 318. | 2,4-difluorophenyl | H | CH₃ | H | phenyl | 3.369 min |
| | | | | | | m/z = 301 [M + H]⁺ |
| 319. | 2,4-difluorophenyl | H | CH₃ | H | 4-fluorophenyl | 3.411 min |
| | | | | | | m/z = 319 [M + H]⁺ |
| 320. | 2,4-difluorophenyl | H | CH₃ | H | 3-fluorophenyl | 3.418 min |
| | | | | | | m/z = 319 [M + H]⁺ |
| 321. | 2,4-difluorophenyl | H | CH₃ | H | 2-fluorophenyl | 3.403 min |
| | | | | | | m/z = 319 [M + H]⁺ |
| 322. | 3-methyl-phenyl | H | Cl | H | phenyl | 2.850 min |
| | | | | | | m/z = 299 [M + H]⁺ |
| 323. | 3-methyl-phenyl | H | CH₃ | H | 2-methyl-phenyl | 3.291 min |
| | | | | | | m/z = 293 [M + H]⁺ |
| 324. | 3-methyl-phenyl | H | CH₂CH₃ | H | phenyl | 3.357 min |
| | | | | | | m/z = 293 [M + H]⁺ |
| 325. | 3-methyl-phenyl | H | CH₃ | H | 4-methoxyphenyl | 3.106 min |
| | | | | | | m/z = 309 [M + H]⁺ |
| 326. | 3-methyl-phenyl | H | H | H | 3-fluorophenyl | 2.980 min |
| | | | | | | m/z = 283 [M + H]⁺ |
| 327. | 3-methyl-phenyl | H | CH₃ | H | 4-fluorophenyl | 3.460 min |
| | | | | | | m/z = 297 [M + H]⁺ |
| 328. | 4-methyl-phenyl | H | CH₃ | H | 2-methyl-phenyl | 3.239 min |
| | | | | | | m/z = 293 [M + H]⁺ |
| 329. | 4-methyl-phenyl | H | H | H | 3-fluorophenyl | 2.958 min |
| | | | | | | m/z = 283 [M + H]⁺ |
| 330. | 4-methyl-phenyl | H | H | H | 2-fluorophenyl | 2.966 min |
| | | | | | | m/z = 283 [M + H]⁺ |
| 331. | 4-methyl-phenyl | H | Cl | H | phenyl | 3.084 min |
| | | | | | | m/z = 299 [M + H]⁺ |
| 332. | 2-bromophenyl | H | CH₃ | H | 3-fluorophenyl | 3.529 min |
| | | | | | | m/z = 361 [M + H]⁺ |
| 333. | 4-bromophenyl | H | CH₃ | H | 4-fluorophenyl | 3.618 min |
| | | | | | | m/z = 363 [M + H]⁺ |
| 334. | 2-chlorophenyl | H | CH₃ | H | phenyl | 3.125 min |
| | | | | | | m/z = 299 [M + H]⁺ |
| 335. | 2-chlorophenyl | H | CH₃ | H | 4-fluorophenyl | 3.478 min, |
| | | | | | | m/z = 317 [M + H]⁺ |
| 336. | 2-chlorophenyl | H | CH₃ | H | 3-fluorophenyl | 3.498 min |
| | | | | | | m/z = 317 [M + H]⁺ |
| 337. | 3-chlorophenyl | H | Br | H | phenyl | 3.273 min |
| | | | | | | m/z = 365 [M + H]⁺ |
| 338. | 2,5-dichlorophenyl | H | CH₃ | H | 3-fluorophenyl | 3.818 min |
| | | | | | | m/z = 351 [M + H]⁺ |
| 339. | 3,5-dichlorophenyl | H | CH₃ | H | 4-fluorophenyl | 3.930 min |
| | | | | | | m/z = 351 [M + H]⁺ |
| 340. | 2-chloro-5-bromophenyl | H | Cl | H | phenyl | 3.349 min |
| | | | | | | m/z = 399 [M + H]⁺ |
| 341. | 2-fluorophenyl | H | H | H | 3,5-dichlorophenyl | 3.718 min |
| | | | | | | m/z = 337 [M + H]⁺ |
| 342. | 2-fluorophenyl | H | CH₃ | H | 4-tert-butyl-phenyl | 4.151 min |
| | | | | | | m/z = 339 [M + H]⁺ |
| 343. | 2-fluorophenyl | H | CH₃ | H | 4-methoxyphenyl | 3.254 min |
| | | | | | | m/z = 313 [M + H]⁺ |
| 344. | 2-fluorophenyl | H | H | H | 3-fluorophenyl | 3.072 min |
| | | | | | | m/z = 287 [M + H]⁺ |
| 345. | 3-fluorophenyl | H | CH₃ | H | 2,4-dichlorophenyl | 3.888 min |
| | | | | | | m/z = 351 [M + H]⁺ |
| 346. | 3-fluorophenyl | H | H | H | 3-fluorophenyl | 3.150 min |
| | | | | | | m/z = 287 [M + H]⁺ |
| 347. | 3-fluorophenyl | H | CH₃ | H | 4-fluorophenyl | 3.376 min, |
| | | | | | | m/z = 301 [M + H]⁺ |
| 348. | 3-fluoro-4-methyl-phenyl | H | CH₃ | H | 4-fluorophenyl | 3.536 min |
| | | | | | | m/z = 315 [M + H]⁺ |
| 349. | 3-fluoro-4-methyl-phenyl | H | CH₃ | H | 3-fluorophenyl | 3.554 min |
| | | | | | | m/z = 315 [M + H]⁺ |
| 350. | 3-fluoro-4-methyl-phenyl | H | CH₂CH₃ | H | phenyl | 3.756 min |
| | | | | | | m/z = 311 [M + H]⁺ |
| 351. | 3-fluoro-4-methyl-phenyl | H | CH₃ | H | 4-tert-butyl-phenyl | 4.184 min |
| | | | | | | m/z = 353 [M + H]⁺ |
| 352. | 3,4-difluorophenyl | H | CH₃ | H | 3-fluorophenyl | 3.476 min |
| | | | | | | m/z = 319 [M + H]⁺ |
| 353. | 2,5-difluorophenyl | H | Br | H | phenyl | 3.432 min |
| | | | | | | m/z = 365 [M + H]⁺ |
| 354. | 2,5-difluorophenyl | H | CH₃ | H | 1,3-benzodioxol-5-yl | 3.289 min |
| | | | | | | m/z = 345 [M + H]⁺ |
| 355. | 2,5-difluorophenyl | H | H | H | 3,5-dichlorophenyl | 3.758 min |
| | | | | | | m/z = 355 [M + H]⁺ |
| 356. | 2,5-difluorophenyl | H | H | H | 4-cyanophenyl | 2.886 min |
| | | | | | | m/z = 312 [M + H]⁺ |
| 357. | 2,6-difluorophenyl | H | CH₃ | H | 4-nitrophenyl | 3.299 min |
| | | | | | | m/z = 346 [M + H]⁺ |
| 358. | 2,6-difluorophenyl | H | CH₃ | H | 4-chlorophenyl | 3.746 min |
| | | | | | | m/z = 335 [M + H]⁺ |
| 359. | 4-fluorophenyl | H | Cl | H | phenyl | 3.308 min, |
| | | | | | | m/z = 303 [M + H]⁺ |
| 360. | 4-fluorophenyl | H | H | H | phenyl | 3.012 min |
| | | | | | | m/z = 269 [M + H]⁺ |
| 361. | 4-fluorophenyl | H | CH₃ | H | 4-chlorophenyl | 3.656 min |
| | | | | | | m/z = 317 [M + H]⁺ |
| 362. | 4-fluorophenyl | H | H | H | 4-cyanophenyl | 2.877 min |
| | | | | | | m/z = 294 [M + H]⁺ |
| 363. | 4-fluorophenyl | H | CH₃ | H | 3-fluorophenyl | 3.356 min |
| | | | | | | m/z = 301 [M + H]⁺ |
| 364. | 2-nitrophenyl | H | CH₃ | H | 3-fluorophenyl | 3.462 min |
| | | | | | | m/z = 328 [M + H]⁺ |
| 365. | 3-nitrophenyl | H | CH₃ | H | 3-fluorophenyl | 3.434 min |
| | | | | | | m/z = 328 [M + H]⁺ |
| 366. | 4-nitrophenyl | H | CH₃ | H | 3-fluorophenyl | 3.410 min |
| | | | | | | m/z = 328 [M + H]⁺ |
| 367. | 3-methyl-4-nitrophenyl | H | CH₃ | H | 4-fluorophenyl | 3.547 min |
| | | | | | | m/z = 342 [M + H]⁺ |
| 368. | 2-methoxyphenyl | H | Cl | H | phenyl | 3.064 min |
| | | | | | | m/z = 315 [M + H]⁺ |
| 369. | 2-methoxyphenyl | H | CH₃ | H | phenyl | 3.064 min |
| | | | | | | m/z = 295 [M + H]⁺ |
| 370. | 3-methoxyphenyl | H | Cl | H | phenyl | 2.702 min |
| | | | | | | m/z = 315 [M + H]⁺ |
| 371. | 3-methoxyphenyl | H | CH₃ | H | phenyl | 2.720 min, |
| | | | | | | m/z = 295 [M + H]⁺ |
| 372. | 3,4-dimethoxyphenyl | H | CH₃ | H | 4-fluorophenyl | 3.143 min |
| | | | | | | m/z = 343 [M + H]⁺ |
| 373. | 3-trifluoromethyl-phenyl | H | CH₂CH₃ | H | phenyl | 3.573 min |
| | | | | | | m/z = 347 [M + H]⁺ |
| 374. | 3-trifluoromethyl-phenyl | H | CH₃ | H | 3-fluorophenyl | 3.777 min |
| | | | | | | m/z = 351 [M + H]⁺ |
| 375. | 3,5-bis(trifluoro-methyl)-phenyl | H | CH₃ | H | 4-fluorophenyl | 4.205 min |
| | | | | | | m/z = 419 [M + H]⁺ |
| 376. | 3,5-bis(trifluoro-methyl)-phenyl | H | CH₃ | H | 3-fluorophenyl | 4.215 min |
| | | | | | | m/z = 419 [M + H]⁺ |
| 377. | 4-chlorophenyl | H | Cl | H | phenyl | 3.195 min |
| | | | | | | m/z = 319 [M + H]⁺ |
| 378. | 4-chlorophenyl | H | CH₃ | H | phenyl | 3.190 min |
| | | | | | | m/z = 299 [M + H]⁺ |
| 379. | 3,5-dichlorophenyl | H | CH₃ | H | 2-methyl-phenyl | 4.052 min |
| | | | | | | m/z = 347 [M + H]⁺ |
| 380. | 3,5-dichlorophenyl | H | CH₃ | H | phenyl | 3.888 min |
| | | | | | | m/z = 333 [M + H]⁺ |
| 381. | 3,5-dichlorophenyl | H | Cl | H | phenyl | 3.921 min |
| | | | | | | m/z = 353 [M + H]⁺ |
| 382. | 4-ethoxyphenyl | H | Cl | H | phenyl | 3.128 min |
| | | | | | | m/z = 329 [M + H]⁺ |
| 383. | 3-hydroxyphenyl | H | CH₃ | H | 4-fluorophenyl | 2.936 min, |
| | | | | | | m/z = 299 [M + H]⁺ |
| 384. | 3-hydroxyphenyl | H | CH₃ | H | 3-fluorophenyl | 2.949 min |
| | | | | | | m/z = 299 [M + H]⁺ |
| 385. | 4-hydroxyphenyl | H | CH₃ | H | 3-fluorophenyl | 2.912 min |
| | | | | | | m/z = 299 [M + H]⁺ |
| 386. | 3-hydroxy-2-naphthyl | H | H | H | 2-fluorophenyl | 3.198 min |
| | | | | | | m/z = 335 [M + H]⁺ |
| 387. | 2-methoxy-4-methylthiophenyl | H | CH₃ | H | 4-fluorophenyl | 3.652 min |
| | | | | | | m/z = 359 [M + H]⁺ |
| 388. | 2-methoxy-4-methylthiophenyl | H | H | H | phenyl | 3.380 min |
| | | | | | | m/z = 327 [M + H]⁺ |
| 389. | 2-methoxy-4-methylthiophenyl | H | CH₃ | H | 4-chlorophenyl | 3.890 min |
| | | | | | | m/z = 375 [M + H]⁺ |
| 390. | 2-methoxy-4-methylthiophenyl | H | H | H | 3-fluorophenyl | 3.448 min |
| | | | | | | m/z = 345 [M + H]⁺ |
| 391. | 2-methoxy-4-methylthiophenyl | H | H | H | 2-fluorophenyl | 3.473 min |
| | | | | | | m/z = 345 [M + H]⁺ |
| 392. | pyrid-2-yl | H | CH₂CH₃ | H | 2-fluorophenyl | 3.275 min; |
| | | | | | | m/z = 298 [M + H]⁺ |
| 393. | pyrid-2-yl | H | CH₂CH₃ | H | 4-fluorophenyl | 3.273 min; |
| | | | | | | m/z = 298 [M + H]⁺ |
| 394. | 6-methylpyrid-2-yl | H | CH₂CH₃ | H | 2-fluorophenyl | 3.502 min; |
| | | | | | | m/z = 312 [M + H]⁺ |
| 395. | 6-methylpyrid-2-yl | H | CH₂CH₃ | H | 2,3-difluorophenyl | 3.577 min; |
| | | | | | | m/z = 330 [M + H]⁺ |
| 396. | 6-bromopyrid-2-yl | H | CH₂CH₃ | H | 4-fluorophenyl | 3.680 min; |
| | | | | | | m/z = 378 [M + H]⁺ |
| 397. | 6-chloropyrid-2-yl | H | CH₃ | H | 3-fluorophenyl | 3.398 min; |
| | | | | | | m/z = 318 [M + H]⁺ |
| 398. | 3-fluoropyrid-2-yl | H | CH₃ | H | phenyl | 2.938 min; |
| | | | | | | m/z = 284 [M + H]⁺ |
| 399. | 3-fluoropyrid-2-yl | H | CH₃ | H | 4-fluorophenyl | 2.998 min; |
| | | | | | | m/z = 302 [M + H]⁺ |
| 400. | 6-fluoropyrid-2-yl | H | CH₃ | H | phenyl | 3.165 min; |
| | | | | | | m/z = 284 [M + H]⁺ |
| 401. | 6-fluoropyrid-2-yl | H | CH₃ | H | 4-fluorophenyl | 3.212 min; |
| | | | | | | m/z = 302 [M + H]⁺ |

TABLE 4

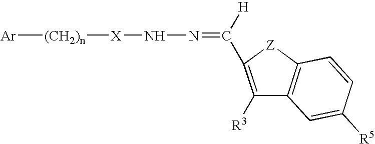

| Example | | | | | | | m.p. or RT* (HPLC/MS) or δ |
|---|---|---|---|---|---|---|---|
| No. | Ar | n | X | Z | R³ | R⁵ | (¹H NMR |
| 402. | 5-chlorothien-2-yl | 0 | SO₂ | O | H | H | 128-130° C. |
| 403. | 2,5-dichlorothien-3-yl | 0 | SO₂ | O | H | H | 152-154° C. |
| 404. | 4-bromo-2,5-dichlorothien-3-yl | 0 | SO₂ | O | H | H | 154-155° C. |
| 405. | thien-2-yl | 1 | CO | O | H | H | |
| 406. | thien-3-yl | 1 | CO | O | H | H | 154-155° C. |
| 407. | phenyl | 1 | CO | O | H | H | 3.232 min; m/z = 279 [M + H]⁺ |
| 408. | 3,4-dimethoxyphenyl | 1 | CO | O | H | H | 3.015 min; m/z = 339 [M + H]⁺ |
| 409. | 3,4-dimethoxyphenyl | 1 | CO | S | H | H | 3.295 min; m/z = 355 [M + H]⁺ |
| 410. | 1-naphthyl | 1 | CO | O | H | H | 3.639 min; m/z = 329 [M + H]⁺ |
| 411. | indol-3-yl | 1 | CO | S | H | H | 3.341 min; m/z = 334 [M + H]⁺ |
| 412. | thien-2-yl | 0 | CO | O | H | H | |
| 413. | thien-2-yl | 0 | CO | CH₂O | Cl | Cl | |
| 414. | thien-2-yl | 0 | CO | S | CH₃ | H | 240-242° C. |
| 415. | thien-2-yl | 0 | CO | S | H | H | 3.375 min; m/z = 287 [M + H]⁺ |
| 416. | thien-2-yl | 0 | CO | O | H | H | 3.078 min; m/z = 271 [M + H]⁺ |
| 417. | 3-methyl-thien-2-yl | 0 | CO | O | H | H | 174-176° C. |
| 418. | 5-methyl-thien-2-yl | 0 | CO | O | H | H | 209-212° C. |
| 419. | 5-methyl-thien-2-yl | 0 | CO | O | Cl | H | 211-212° C. |
| 420. | 5-chlorothien-2-yl | 0 | CO | O | H | H | 205-206° C. |
| 421. | 5-bromothien-2-yl | 0 | CO | O | H | H | 232-234° C. |
| 422. | 5-bromothien-2-yl | 0 | CO | O | Cl | H | 236-237° C. |
| 423. | 3-chloro-4-methyl-thien-2-yl | 0 | CO | O | H | H | 234-237° C. |
| 424. | 3-chloro-4-methyl-thien-2-yl | 0 | CO | O | Cl | H | 208° C. |
| 425. | benzothien-2-yl | 0 | CO | O | H | H | 3.577 min; m/z = 321 [M + H]⁺ |
| 426. | benzothien-2-yl | 0 | CO | S | H | H | 3.916 min; m/z = 337 [M + H]⁺ |
| 427. | 3-ethoxythien-2-yl | 0 | CO | O | H | H | 180-182° C. |
| 428. | fur-2-yl | 0 | CO | S | H | H | 2.906 min; m/z = 271 [M + H]⁺ |
| 429. | fur-2-yl | 0 | CO | O | H | H | 2.661 min; m/z = 255 [M + H]⁺ |
| 430. | isoxazol-5-yl | 0 | CO | O | H | H | |
| 431. | 4-methyl-imidazol-5-yl | 0 | CO | O | H | H | 2.077 min; m/z = 269 [M + H]⁺ |
| 432. | 1,5-dimethylpyrazol-3-yl | 0 | CO | O | H | H | |
| 433. | 1,3-dimethylpyrazol-5-yl | 0 | CO | O | H | H | |
| 434. | 4-chloro-1,3-dimethylpyrazol-5-yl | 0 | CO | O | H | H | 172-174° C. |
| 435. | pyrid-2-yl | 0 | CO | O | H | H | 3.799 min; m/z = 266 [M + H]⁺ |
| 436. | pyrid-2-yl | 0 | CO | S | H | H | 3.044 min; m/z = 282 [M + H]⁺ |
| 437. | pyrid-3-yl | 0 | CO | O | H | H | 2.095 min; m/z = 266 [M + H]⁺ |
| 438. | 2-phenoxypyrid-3-yl | 0 | CO | O | H | H | 3.342 min; m/z = 358 [M + H]⁺ |
| 439. | pyrid-4-yl | 0 | CO | S | H | H | 2.305 min; m/z = 282 [M + H]⁺ |
| 440. | pyrid-4-yl | 0 | CO | O | H | H | 2.090 min; m/z = 266 [M + H]⁺ |
| 441. | 2-chloropyrid-4-yl | 0 | CO | O | H | H | 230-231° C. |
| 442. | pyrazin-2-yl | 0 | CO | O | H | H | |
| 443. | dibenzo-4H-pyran-4-yl | 0 | CO | O | H | H | 3.786 min; m/z = 369 [M + H]⁺ |
| 444. | phenyl | 0 | CO | O | H | H | 2.913 min; m/z = 265 [M + H]⁺ |
| 445. | 3-methylphenyl | 0 | CO | O | H | H | 3.155 min; m/z = 279 [M + H]⁺ |
| 446. | 4-methylphenyl | 0 | CO | O | H | H | 3.129 min; m/z = 279 [M + H]⁺ |
| 447. | 2-methoxyphenyl | 0 | CO | O | H | H | 3.122 min; m/z = 295 [M + H]⁺ |
| 448. | 3-methoxyphenyl | 0 | CO | S | H | H | 3.233 min; m/z = 311 [M + H]⁺ |
| 449. | 3-methoxyphenyl | 0 | CO | O | H | H | 3.001 min; m/z = 295 [M + H]⁺ |
| 450. | 2-fluorophenyl | 0 | CO | O | H | H | 2.979 min; m/z = 283 [M + H]⁺ |
| 451. | 2,5-difluorophenyl | 0 | CO | O | H | H | 3.095 min; m/z = 301 [M + H]⁺ |
| 452. | 3-fluoro-4-methylphenyl | 0 | CO | O | H | H | 3.250 min; m/z = 297 [M + H]⁺ |
| 453. | 3-bromophenyl | 0 | CO | O | H | H | 3.345 min; m/z = 344 [M + H]⁺ |
| 454. | 3-methyl-phenyl | 0 | CO | S | H | H | 3.369 min |
| | | | | | | | m/z = 295 [M + H]⁺ |
| 455. | 2-nitrophenyl | 0 | CO | S | H | H | 3.256 min |
| | | | | | | | m/z = 326 [M + H]⁺ |
| 456. | 4-trifluoromethyl-phenyl | 0 | CO | S | H | H | 3.657 min |
| | | | | | | | m/z = 349 [M + H]⁺ |
| 457. | 3-bromophenyl | 0 | CO | S | H | H | 3.560 min |
| | | | | | | | m/z = 361 [M + H]⁺ |
| 458. | 2-chlorophenyl | 0 | CO | S | H | H | 3.352 min |
| | | | | | | | m/z = 315 [M + H]⁺ |
| 459. | 2,5-dichlorophenyl | 0 | CO | S | H | H | 3.705 min |
| | | | | | | | m/z = 349 [M + H]⁺ |
| 460. | 2-methoxyphenyl | 0 | CO | S | H | H | 3.424 min |
| | | | | | | | m/z = 311 [M + H]⁺ |
| 461. | 3,4,5-trimethoxyphenyl | 0 | CO | S | H | H | 3.241 min |
| | | | | | | | m/z = 371 [M + H]⁺ |
| 462. | 3,4-dimethoxyphenyl | 0 | CO | S | H | H | 3.082 min |
| | | | | | | | m/z = 341 [M + H]⁺ |
| 463. | 3,5-bis(trifluoromethyl)phenyl | 0 | CO | S | H | H | 4.119 min |
| | | | | | | | m/z = 417 [M + H]⁺ |
| 464. | 3-methyl-4-nitrophenyl | 0 | CO | S | H | H | 3.477 min |
| | | | | | | | m/z = 340 [M + H]⁺ |
| 465. | phenyl | 0 | CO | S | H | H | 3.169 min |
| | | | | | | | m/z = 281 [M + H]⁺ |
| 466. | 4-hydroxyphenyl | 0 | CO | S | H | H | 2.801 min |
| | | | | | | | m/z = 297 [M + H]⁺ |
| 467. | 2-fluorophenyl | 0 | CO | S | H | H | 3.225 min |
| | | | | | | | m/z = 299 [M + H]⁺ |
| 468. | 2,5-difluorophenyl | 0 | CO | S | H | H | 3.339 min |
| | | | | | | | m/z = 317 [M + H]⁺ |
| 469. | 2-methoxy-4-methylthiophenyl | 0 | CO | S | H | H | 3.587 min |
| | | | | | | | m/z = 357 [M + H]⁺ |
| 470. | 3,4-difluorophenyl | 0 | CO | S | H | H | 3.380 min |
| | | | | | | | m/z = 317 [M + H]⁺ |
| 471. | 3-hydroxy-2-naphthyl | 0 | CO | O | H | H | 3.471 min |
| | | | | | | | m/z = 331 [M + H]⁺ |
| 472. | 4-phenyl-phenyl | 0 | CO | O | H | H | 3.610 min |
| | | | | | | | m/z = 341 [M + H]⁺ |
| 473. | 2-bromophenyl | 0 | CO | O | H | H | 3.162 min |
| | | | | | | | m/z = 343 [M + H]⁺ |
| 474. | 2-naphthyl | 0 | CO | O | H | H | 3.402 min |
| | | | | | | | m/z = 315 [M + H]⁺ |
| 475. | 4-bromophenyl | 0 | CO | O | H | H | 3.317 min |
| | | | | | | | m/z = 345 [M + H]⁺ |
| 476. | 4-chlorophenyl | 0 | CO | O | H | H | 3.253 min |
| | | | | | | | m/z = 299 [M + H]⁺ |
| 477. | 2-chlorophenyl | 0 | CO | O | H | H | 3.112 min |
| | | | | | | | m/z = 299 [M + H]⁺ |
| 478. | 2,5-dichlorophenyl | 0 | CO | O | H | H | 3.436 min |
| | | | | | | | m/z = 333 [M + H]⁺ |
| 479. | 4-tert-butyl-phenyl | 0 | CO | O | H | H | 3.707 min |
| | | | | | | | m/z = 321 [M + H]⁺ |
| 480. | 3,4-dimethoxyphenyl | 0 | CO | O | H | H | 2.858 min |
| | | | | | | | m/z = 325 [M + H]⁺ |
| 481. | 4-methoxyphenyl | 0 | CO | O | H | H | 2.980 min |
| | | | | | | | m/z = 295 [M + H]⁺ |
| 482. | 2,4-dichlorophenyl | 0 | CO | O | H | H | 3.459 min |
| | | | | | | | m/z = 333 [M + H]⁺ |
| 483. | 3-trifluoromethyl-phenyl | 0 | CO | O | H | H | 3.479 min |
| | | | | | | | m/z = 333 [M + H]⁺ |
| 484. | 4-fluorophenyl | 0 | CO | O | H | H | 2.999 min |
| | | | | | | | m/z = 283 [M + H]⁺ |
| 485. | 3-fluorophenyl | 0 | CO | O | H | H | 3.037 min |
| | | | | | | | m/z = 283 [M + H]⁺ |
| 486. | 2,6-difluorophenyl | 0 | CO | O | H | H | 3.075 min |
| | | | | | | | m/z = 301 [M + H]⁺ |
| 487. | 3,5-dichlorophenyl | 0 | CO | O | H | H | 3.631 min |
| | | | | | | | m/z = 333 [M + H]⁺ |
| 488. | 2-methoxy-4-methylthiophenyl | 0 | CO | O | H | H | 3.400 min |
| | | | | | | | m/z = 341 [M + H]⁺ |
| 489. | 3-methoxythien-2-yl | 0 | CO | O | H | H | 2.897 min |
| | | | | | | | m/z = 301 [M + H]⁺ |
| 490. | 4-trifluoromethyl-pyrid-3-yl | 0 | CO | NMe | H | H | 3.082 min. |
| | | | | | | | m/z = 347 [M + H]⁺ |

*RT = retention time HPLC/MS

### 2. EXAMPLES OF ACTION AGAINST PESTS

The action of the compounds of formula I against pests was demonstrated by the following experiments.

2.1 Southern Armyworm (Spodoptera eridania), 2nd Instar Larvae

The active compounds were formulated for testing the activity against insects and arachnids as a 10.000 ppm solution in a mixture of 35% acetone and water, which was diluted with water, if needed.

A Sieva lima bean leaf expanded to 78 cm in length is dipped in the test solution with agitation for 3 seconds and allowed to dry in a hood. The leaf is then placed in a 100×10 mm petri dish containing a damp filter paper on the bottom and ten 2nd instar caterpillars. At 5 days, observations are made of mortality, reduced feeding, or any interference with normal molting.

In this test, compounds nos. 18, 97, 101, 134, 160, 161, 162, 164, 166, 174, 175, 177, 183, 185, 190, 192, 198, 238, 318, 406, 427 and 445 at 300 ppm showed over 80% mortality in comparison with untreated controls.

2.2 Cotton Aphid (aphis gossypii)

The active compounds were formulated in 50:50 acetone:water and 100 ppm Kinetic® surfactant.

Cotton plants at the cotyledon stage (one plant per pot) were infested by placing a heavily infested leaf from the main colony on top of each cotyledon. The aphids were allowed to transfer to the host plant overnight, and the leaf used to transfer the aphids was removed. The cotyledons were dipped in the test solution and allowed to dry. After 5 days, mortality counts were made.

In this test, compounds nos. 8, 67, 70, 71, 120, 121, 126, 130, 131, 156, 157, 159, 181, 194, 202, 203, 207, 236, 240, 277, 314, 319, 392, 394, 395, 398, 399, 429, 442, 444, 447, 450 and 451 at 300 ppm showed over 75% mortality in comparison with untreated controls.

2.3 Green Peach Aphid (Myzus persicae)

The active compounds were formulated in 50:50 acetone:water and 100 ppm Kinetic® surfactant.

Pepper plants in the 2^{nd} leaf-pair stage (variety ‘California Wonder’) were infested with approximately 40 laboratory-reared aphids by placing infested leaf sections on top of the test plants. The leaf sections were removed after 24 hr. The leaves of the intact plants were dipped into gradient solutions of the test compound and allowed to dry.

Test plants were maintained under fluorescent light (24 hour photoperiod) at about 25° C. and 20-40% relative humidity. Aphid mortality on the treated plants, relative to mortality on check plants, was determined after 5 days.

In this test, compounds nos. 3, 10, 14, 19, 20, 76, 128, 152, 173, 186, 194, 195, 197, 198, 200, 204, 235, 237, 278, 320, 321, 393, 396, 397, 400, 461, 407, 408, 409, 411 and 453 at 300 ppm showed over 75% mortality in comparison with untreated controls.

2.4 Bean Aphid (aphis fabae)

The active compounds were formulated in 50:50 acetone:water and 100 ppm Kinetic® surfactant.

Nasturtium plants grown in Metro mix in the 1^{st} leaf-pair stage (variety ‘Mixed Jewle’) were infested with approximately 2-30 laboratory-reared aphids by placing infested cut plants on top of the test plants. The cut plants were removed after 24 hr. Each plant was dipped into the test solution to provide complete coverage of the foliage, stem, protruding seed surface and surrounding cube surface and allowed to dry in the fume hood. The treated plants were kept at about 25° C. with continuous fluorescent light. Aphid mortality was determined after 3 days.

In this test, compounds nos. 18, 69, 71, 126, 157, 159, 168, 169, 170, 171, 184, 191, 196, 199, 202, 210, 253, 436, 442, 444 and 446 at 300 ppm showed over 75% mortality in comparison with untreated controls.

2.5 Silverleaf Whitefly (bemisia argentifolii)

The active compounds were formulated in 50:50 acetone:water and 100 ppm Kinetic® surfactant.

Selected cotton plants were grown to the cotyledon state (one plant per pot). The cotyledons were dipped into the test solution to provide complete coverage of the foliage and placed in a well-vented area to dry. Each pot with treated seedling was placed in a plastic cup and 10 to 12 whitefly adults (approximately 3-5 day old) were introduced. The insects were collected using an aspirator and an 0.6 cm, non-toxic Tygon® tubing (R-3603) connected to a barrier pipette tip. The tip, containing the collected insects, was then gently inserted into the soil containing the treated plant, allowing insects to crawl out of the tip to reach the foliage for feeding. The cups were covered with a reusable screened lid (150 micron mesh polyester screen PeCap from Tetko Inc). Test plants were maintained in the holding room at about 25° C. and 20-40% relative humidity for 3 days avoiding direct exposure to the fluorescent light (24 hour photoperiod) to prevent trapping of heat inside the cup. Mortality was assessed 3 days after treatment of the plants.

In this test, compounds nos. 2, 6, 50, 156, 158, 175, 183, 187, 189, 193, 406 and 435 at 300 ppm showed over 80% mortality compared to untreated controls.

2.6 2-Spotted Spider Mite (tetranychus urticae, OP-Resistant Strain)

The active compounds were formulated in 50:50 acetone:water and 100 ppm Kinetic® surfactant.

Sieva lima bean plants with primary leaves expanded to 7-12 cm were infested by placing on each a small piece from an infested leaf (with about 100 mites) taken from the main colony. This was done at about 2 hours before treatment to allow the mites to move over to the test plant to lay eggs. The piece of leaf used to transfer the mites was removed. The newly-infested plants were dipped in the test solution and allowed to dry. The test plants were kept under fluorescent light (24 hour photoperiod) at about 25° C. and 20-40% relative humidity. After 5 days, one leaf was removed and mortality counts were made.

In this test, compounds nos. 21, 91, 96, 114, 138, 183, 429 and 452 at 300 ppm showed over 75% mortality compared to untreated controls.

2.7 Orchid Thrips (dichromothrips corbetti)

Dichromothrips corbetti adults used for bioassay were obtained from a colony maintained continuously under laboratory conditions. For testing purposes, the test compound was diluted to a concentration of 500 ppm (wt compound:vol diluent) in a 1:1 mixture of acetone:water, plus 0.01% Kinetic® surfactant.

Thrips potency of each compound was evaluated by using a floral-immersion technique. Plastic petri dishes were used as test arenas. All petals of individual, intact orchid flowers were dipped into treatment solution for approximately 3 seconds and allowed to dry for 2 hours. Treated flowers were placed into individual petri dishes along with 10-15 adult thrips. The petri dishes were then covered with lids. All test arenas were held under continuous light and a temperature of about 28° C. for duration of the assay. After 4 days, the numbers of live thrips were counted on each flower, and along inner walls of each petri dish. The level of thrips mortality was extrapolated from pretreatment thrips numbers.

In this test, compounds nos. 103, 105 and 144 at 500 ppm showed over 95% mortality compared to untreated controls.

1-21. (canceled)

22. A method for combating insects or arachnids which comprises contacting the insects or the arachnids, their habitat, breeding ground, food supply, plant, seed, soil, area, material or environment in which the insects or the arachnids are growing or may grow, or the materials, plants, seeds, soils, surfaces or spaces to be protected from insect or arachnid attack or infestation with a pesticidally effective amount of a compound of the general formula I or a salt thereof. 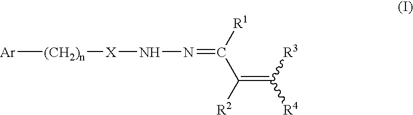
wherein:
Ar is a cyclic radical selected from phenyl, naphthyl and a 5- or 6-membered heterocyclic radical with 1 to 4 heteroatoms which are selected, independently of one another, from O, N and S, where the 5- or 6-membered heterocyclic radical may be fused to 1 or 2 phenyl rings, and where the cyclic radical may have 1, 2, 3, 4 or 5 substituents R^{a} which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO—, phenyl, benzyl and phenoxy, wherein phenyl, benzyl and phenoxy may be substituted by 1, 2, 3, 4 or 5 substituents R^{b} which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO—;
X is CO or SO₂;
R¹ is H, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₂-C₁₀-haloalkynyl or phenyl which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO—;
R² and R³ are independently of one another H, halogen, cyano, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, hydroxy-C₁-C₁₀-alkyl, C₁-C₁₀-alkoxy-C₁-C₁₀-alkyl, halo-C₁-C₁₀-alkoxy-C₁-C₁₀-alkyl, C₁-C₁₀-alkoxycarbonyl-C₁-C₁₀-alkyl, halo-C₁-C₁₀-alkoxycarbonyl-C₁-C₁₀-alkyl or phenyl which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO;
R⁴ is an aromatic radical selected from phenyl, pyridyl, pyrimidyl, furyl, and thienyl, where the aromatic radical may carry 1 to 5 substituents R^{c} which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO— and phenoxy which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO; or
R² and R⁴ together with the carbon atoms to which they are bound form a phenyl ring or a 5- or 6-membered heterocyclic ring with 1 or 2 heteroatoms which are selected, independently of one another, from O, N and S, where the phenyl ring and the 5- or 6-membered heterocyclic ring is fused to a phenyl ring, and where the phenyl ring and the 5- or 6-membered heterocyclic ring and/or the phenyl ring to which they are fused may carry 1, 2, 3 or 4 substituents R^{e} which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₂-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₂-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO, phenyl which is unsubstituted or is substituted by 1, 2 or 3 substituents which are selected, independently of one another, from C₁-C₄-alkyl, C₁-C₄-haloalkyl, C₁-C₄-alkoxy and halogen, and phenoxy which may be substituted by 1, 2, 3, 4 or 5 substituents R^{f} which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO, and where the 5- or 6-membered heterocyclic ring may contain 1 carbonyl group as a ring member;
R⁵ and R⁶ independently of one another are H or C₁-C₁₀-alkyl; and
n is 0 or 1.

23. The method as claimed in claim 22, where
Ar is a cyclic radical selected from phenyl, naphthyl and a 5- or 6-membered heterocyclic radical with 1 to 3 heteroatoms which are selected, independently of one another, from O, N and S, where the 5- or 6-membered heterocyclic radical may be fused to 1 or 2 phenyl rings, and where the cyclic radical may have 1, 2, 3 or 4 substituents R^{a} which are selected, independently of one another, from halogen, hydroxy, C₁-C₄-alkyl, C₁-C₄-haloalkyl, C₁-C₄-alkoxy, C₁-C₄-haloalkoxy, C₁-C₄-alkylthio, C₁-C₄-haloalkylthio, phenyl which is unsubstituted or substituted by 1, 2 or 3 substituents R^{b} which are selected, independently of one another, from halogen, C₁-C₄-alkyl, C₁-C₄-haloalkyl and C₁-C₄-alkoxy, and phenoxy which is unsubstituted or substituted by 1, 2 or 3 substituents R^{b} which are selected, independently of one another, from halogen, C₁-C₄-alkyl, C₁-C₄-haloalkyl and C₁-C₄-alkoxy.

24. The method as claimed in claim 23, where
Ar is a cyclic radical selected from thienyl, furyl, pyrazolyl, imidazolyl, isoxazolyl, thiazolyl, thiadiazolyl, phenyl, pyridyl, pyrazinyl, naphthyl, dibenzopyranyl, indolyl or benzothienyl, and where the cyclic radical may be substituted by 1, 2 or 3 substituents R^{a} which are selected, independently of one another, from halogen, hydroxy, C₁-C₄-alkyl, C₁-C₄-haloalkyl, C₁-C₄-alkoxy, C₁-C₄-haloalkoxy, phenyl which is unsubstituted or substituted by 1, 2 or 3 substituents R^{b} which are selected, independently of one another, from halogen, C₁-C₄-alkyl, C₁-C₄-haloalkyl and C₁-C₄-alkoxy, and phenoxy which is unsubstituted or substituted by 1, 2 or 3 substituents R^{b} which are selected, independently of one another, from halogen, C₁-C₄-alkyl, C₁-C₄-alkoxy and C₁-C₄-haloalkyl.

25. The method as claimed in claim 24 where
Ar is a cyclic radical selected from thienyl, furyl, pyrazolyl, imidazolyl, isoxazolyl, phenyl, pyridyl, pyrazinyl, naphthyl, indolyl or benzothienyl, and where the cyclic radical may be substituted by 1 or 2 substituents R^{a} which are selected, independently of one another, from halogen, hydroxy, C₁-C₄-alkyl, C₁-C₄-haloalkyl, C₁-C₄-alkoxy and C₁-C₄-haloalkoxy.

26. The method as claimed in claim 22, where
R¹ is H, C₁-C₄-alkyl or C₁-C₄-haloalkyl.

27. The method as claimed in claim 26, where R¹ is H or methyl.

28. The method as claimed in claim 22, where
R² and R⁴ together with the carbon atoms to which they are bound form a 5- or 6-membered heterocyclic ring with 1 or 2 heteroatoms which are selected, independently of one another, from O, N and S, where the 5- or 6-membered heterocyclic ring is fused to a phenyl ring, and where the 5- or 6-membered heterocyclic ring and/or the phenyl ring to which it is fused may carry 1, 2, 3 or 4 substituents R^{e} which are selected, independently of one another, from halogen, C₁-C₄-alkyl, C₁-C₄-haloalkyl, C₁-C₄-alkoxy, C₁-C₄-haloalkoxy, C₁-C₄-haloalkylthio, cyano, nitro, phenyl which is unsubstituted or is substituted by 1, 2 or 3 substituents which are selected, independently of one another, from C₁-C₄-alkyl, C₁-C₄-haloalkyl, C₁-C₄-alkoxy and halogen; and phenoxy which is unsubstituted or substituted by 1, 2 or 3 substituents R^{f} which are selected, independently of one another, from C₁-C₄-alkyl, C₁-C₄-haloalkyl, C₁-C₄-alkoxy and halogen, and where the 5- or 6-membered heterocyclic ring may contain 1 carbonyl group as a ring member.

29. The method as claimed in claim 28, where
R² and R⁴ together with the carbon atoms to which they are bound form a benzofuranyl, benzothienyl, indolyl, chromenyl or chromenonyl moiety, and where the moiety may carry 1, 2, 3 or 4 substituents R^{e} which are selected, independently of one another, from halogen, C₁-C₄-alkyl, C₁-C₄-haloalkyl, C₁-C₄-haloalkoxy, C₁-C₄-haloalkylthio, cyano and nitro.

30. The method as claimed in claim 29, where
R² and R⁴ together with the carbon atoms to which they are bound form a benzofuranyl, benzothienyl or chromenyl moiety, and where the moiety may be substituted by 1, 2 or 3 substituents R^{e} which are selected, independently of one another, from C₁-C₄-alkyl, C₁-C₄-haloalkyl and halogen.

31. The method as claimed in claim 22, where
R² is H, C₁-C₁₀-alkyl, C₁-C₁₀-haloalkyl, halogen, phenyl or cyano.

32. The method as claimed in claim 22, where
R³ is H, C₁-C₄-alkyl, halogen or phenyl.

33. The method as claimed in claim 22, where
R⁴ is an aromatic radical selected from phenyl, pyridyl, pyrimidyl, furyl, or thienyl, where the aromatic radical may carry 1, 2, 3, 4 or 5 substituents R^{c} which are selected, independently of one another, from hydroxy, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, cyano, nitro, NR⁵R⁶ and phenoxy which may be substituted by C₁-C₄-haloalkyl; and
R⁵ and R⁶ are defined as in claim 22.

34. The method as claimed in claim 33, where
R⁴ is phenyl which may 1, 2, 3, 4 or 5 substituents R^{c} which are selected, independently of one another, from hydroxy, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, cyano, nitro, NR⁵R⁶ and phenoxy which may be substituted by C₁-C₄-haloalkyl.

35. The method as claimed in claim 22, where
R² is H, C₁-C₁₀-alkyl, C₁-C₁₀-haloalkyl, halogen, phenyl or cyano;
R³ is H, C₁-C₄-alkyl, halogen or phenyl; and
R⁴ is an aromatic radical selected from phenyl, pyridyl, pyrimidyl, furyl, or thienyl, where the aromatic radical may carry 1, 2, 3 or 4 substituents R^{c} which are selected, independently of one another, from hydroxy, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, cyano, nitro, NR⁵R⁶ and phenoxy which may be substituted by C₁-C₄-haloalkyl; and
R⁵ and R⁶ are defined as in claim 22.

36. The method as claimed in claim 35, where
R⁴ is phenyl, which may carry 1, 2, 3 or 4 substituents R^{c} which are selected, independently of one another, from halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, cyano, nitro, NR⁵R⁶ and phenoxy which may be substituted with C₁-C₄-haloalkyl.

37. The method as claimed in claim 35, where
R² is H, C₁-C₁₀-alkyl or halogen;
R³ is H or halogen; and
R⁴ is phenyl which may carry 1, 2 or 3 substituents R^{c} which are selected, independently of one another, from halogen, C₁-C₄-alkyl, C₁-C₄-haloalkyl, C₁-C₄-alkoxy, C₁-C₄-haloalkoxy, C₁-C₄-alkylthio C₁-C₄-haloalkylthio, cyano and nitro.

38. A method for protecting crops from attack or infestation by insects or arachnids comprising contacting a crop with a pesticidally effective amount of a compound of formula I as defined in claim 22.

39. The method as claimed in claim 38, where the compound of the formula I is applied at a rate of from 0.1 g/ha to 4000 g/ha.

40-42. (canceled)

43. A pyridyl compound of the general formula Ia 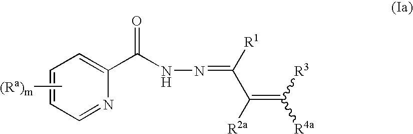
wherein
R^{a} is independently of one another halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO—, phenyl, benzyl and phenoxy, wherein phenyl, benzyl and phenoxy may be substituted by 1, 2, 3, 4 or 5 substituents R^{b} which are selected, independently of one another from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO—;
R¹ is H, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₂-C₁₀-haloalkynyl or phenyl which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO—;
R³ is H, halogen, cyano, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, hydroxy-C₁-C₁₀-alkyl, C₁-C₁₀-alkoxy-C₁-C₁₀-alkyl, halo-C₁-C₁₀-alkoxy-C₁-C₁₀-alkyl, C₁-C₁₀-alkoxycarbonyl-C₁-C₁₀-alkyl, halo-C₁-C₁₀-alkoxycarbonyl-C₁-C₁₀-alkyl or phenyl which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO;
m is 0, 1, 2 or 3,
R^{2a} is C₁-C₄ alkyl;
R^{4a} is phenyl, which may carry 1, 2, 3 or 4 radicals R^{c} which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO— and phenoxy which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO; and
R⁵ and R⁶ independently of one another are H or C₁-C₁₀-alkyl;
provided that either
i) m is not 0 or
ii) R^{4a} carries at least one substituent R^{c} being different from hydrogen
iii) or R¹ is different from hydrogen,
iv) or R^{2a} is different from methyl.

44. An isoxazolyl compound of the formula Ib 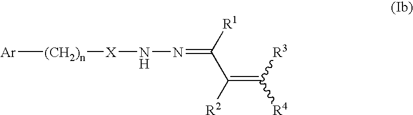
wherein
n is 0 or 1;
X is CO or SO₂;
R¹ is H, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₂-C₁₀-haloalkynyl or phenyl which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶—CO—;
R² is H, halogen, cyano, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, hydroxy-C₁-C₁₀-alkyl, C₁-C₁₀-alkoxy-C₁-C₁₀-alkyl, halo-C₁-C₁₀-alkoxy-C₁-C₁₀-alkyl, C₁-C₁₀-alkoxycarbonyl-C₁-C₁₀-alkyl, halo-C₁-C₁₀-alkoxycarbonyl-C₁-C₁₀-alkyl or phenyl which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO;
R³ is H, halogen, cyano, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, hydroxy-C₁-C₁₀-alkyl, C₁-C₁₀-alkoxy-C₁-C₁₀-alkyl, halo-C₁-C₁₀-alkoxy-C₁-C₁₀-alkyl, C₁-C₁₀-alkoxycarbonyl-C₁-C₁₀-alkyl, halo-C₁-C₁₀-alkoxycarbonyl-C₁-C₁₀-alkyl or phenyl which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO;
R⁴ is an aromatic radical selected from phenyl, pyridyl, pyrimidyl, furyl, and thienyl, where the aromatic radical may carry 1 to 5 substituents R^{c} which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO— and phenoxy which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO; or
R² and R⁴ together with the carbon atoms to which they are bound form a phenyl ring or a 5- or 6-membered heterocyclic ring with 1 or 2 heteroatoms which are selected, independently of one another, from O, N and S, where the phenyl ring and the 5- or 6-membered heterocyclic ring is fused to a phenyl ring, and where the phenyl ring and the 5- or 6-membered heterocyclic ring and/or the phenyl ring to which they are fused may carry 1, 2, 3 or 4 substituents R^{e} which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₂-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₂-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO, phenyl which is unsubstituted or is substituted by 1, 2 or 3 substituents which are selected, independently of one another, from C₁-C₄-alkyl, C₁-C₄-haloalkyl, C₁-C₄-alkoxy and halogen, and phenoxy which may be substituted by 1, 2, 3, 4 or 5 substituents R^{f} which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO, and where the 5- or 6-membered heterocyclic ring may contain 1 carbonyl group as a ring member;
Ar is isoxazolyl, which may carry 1 or 2 substituents R^{a} which are selected from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO—, phenyl, benzyl and phenoxy, wherein phenyl, benzyl and phenoxy may be substituted by 1, 2, 3, 4 or 5 substituents R^{b} which are selected, independently of one another from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO—; and
R⁵ and R⁶ independently of one another are H or C₁-C₁₀-alkyl;
provided that Ar does not carry an optionally substituted phenyl group if Ar is substituted 4-isoxazolyl.

45. A pyrazolyl compound of the formula Ic 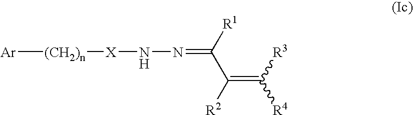
wherein
n is 0 or 1;
X is CO or SO₂;
R¹ is H, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₂-C₁₀-haloalkynyl or phenyl which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO—;
R² and R³ are independently of one another, H, halogen, cyano, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, hydroxy-C₁-C₁₀-alkyl, C₁-C₁₀-alkoxy-C₁-C₁₀-alkyl, halo-C₁-C₁₀-alkoxy-C₁-C₁₀-alkyl, C₁-C₁₀-alkoxycarbonyl-C₁-C₁₀-alkyl, halo-C₁-C₁₀-alkoxycarbonyl-C₁-C₁₀-alkyl or phenyl which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO;
R⁴ is an aromatic radical selected from phenyl, pyridyl, pyrimidyl, furyl, and thienyl, where the aromatic radical may carry 1 to 5 substituents R^{c} which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO— and phenoxy which may be substituted by 1 to 5 substituents which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO; or
R² and R⁴ together with the carbon atoms to which they are bound form a phenyl ring or a 5- or 6-membered heterocyclic ring with 1 or 2 heteroatoms which are selected, independently of one another, from O, N and S, where the phenyl ring and the 5- or 6-membered heterocyclic ring is fused to a phenyl ring, and where the phenyl ring and the 5- or 6-membered heterocyclic ring and/or the phenyl ring to which they are fused may carry 1, 2, 3 or 4 substituents R^{e} which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₂-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₂-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO, phenyl which is unsubstituted or is substituted by 1, 2 or 3 substituents which are selected, independently of one another, from C₁-C₄-alkyl, C₁-C₄-haloalkyl, C₁-C₄-alkoxy and halogen, and phenoxy which may be substituted by 1, 2, 3, 4 or 5 substituents R^{f} which are selected, independently of one another, from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO, and where the 5- or 6-membered heterocyclic ring may contain 1 carbonyl group as a ring member;
Ar is pyrazolyl which carries a substituent R^{a2} on the pyrazol nitrogen atom, and which may carry 1 or 2 substituents R^{a} which are independently of one another halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl, R⁵R⁶N—CO—, phenyl, benzyl and phenoxy, wherein phenyl, benzyl and phenoxy may be substituted by 1, 2, 3, 4 or 5 substituents R^{b} which are selected, independently of one another from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO—;
wherein R^{a2} is selected from C₁-C₁₀-alkyl, C₁-C₁₀-haloalkyl, C₃-C₁₀-cylcoalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, phenyl and benzyl, wherein phenyl and benzyl may be unsubstituted or substituted by 1, 2, 3, 4 or 5 substituents R^{b} which are selected, independently of one another from halogen, cyano, nitro, C₁-C₁₀-alkyl, C₁-C₁₀-haloalkyl, C₃-C₁₀-cycloalkyl, C₃-C₁₀-halocycloalkyl, C₂-C₁₀-alkenyl, C₂-C₁₀-haloalkenyl, C₂-C₁₀-alkynyl, C₃-C₁₀-haloalkynyl, C₁-C₁₀-alkoxy, C₁-C₁₀-haloalkoxy, C₂-C₁₀-alkenyloxy, C₂-C₁₀-haloalkenyloxy, C₂-C₁₀-alkynyloxy, C₃-C₁₀-haloalkynyloxy, C₁-C₁₀-alkylthio, C₁-C₁₀-haloalkylthio, C₁-C₁₀-alkylsulfinyl, C₁-C₁₀-haloalkylsulfinyl, C₁-C₁₀-alkylsulfonyl, C₁-C₁₀-haloalkylsulfonyl, hydroxy, NR⁵R⁶, C₁-C₁₀-alkoxycarbonyl, C₁-C₁₀-haloalkoxycarbonyl, C₂-C₁₀-alkenyloxycarbonyl, C₂-C₁₀-haloalkenyloxycarbonyl, C₁-C₁₀-alkylcarbonyl, C₁-C₁₀-haloalkylcarbonyl and R⁵R⁶N—CO—; and
R⁵ and R⁶ independently of one another are H or C₁-C₁₀-alkyl.
